(19) United States
(12) Patent Application Publication
(10) Pub. No.: US 2026/0043411 A1
(43) Pub. Date: Feb. 12, 2026

(54) PORTABLE FAN, DRIVE CIRCUIT, HANDHELD FAN, AND NECK FAN

(71) Applicant: Shenzhen Jisu Technology Co., Ltd., SHENZHEN (CN)

(72) Inventors: Guanzheng ZHENG, SHENZHEN (CN); Jiahang XIE, SHENZHEN (CN); Shuiyong YUAN, SHENZHEN (CN); Xiangfu LI, SHENZHEN (CN); Haijun GAO, SHENZHEN (CN); Cheng YE, SHENZHEN (CN); Cunfu HUANG, SHENZHEN (CN); Weijie ZHENG, SHENZHEN (CN)

(73) Assignee: Shenzhen Jisu Technology Co., Ltd., SHENZHEN (CN)

(21) Appl. No.: 19/363,458

(22) Filed: Oct. 20, 2025

Related U.S. Application Data
(63) Continuation of application No. 18/927,186, filed on Oct. 25, 2024.
Application No. 18/927,186 is a continuation-in-part of application No. PCT/CN2023/099539, filed on Jun. 9, 2023.

(30) Foreign Application Priority Data
May 11, 2022 (CN) 202221176136.4
Jun. 14, 2022 (CN) 202221486507.9
Jul. 25, 2022 (CN) 202221950040.9
Oct. 21, 2022 (CN) 202222795438.6
Nov. 2, 2022 (CN) 202222918924.2
Nov. 2, 2022 (CN) 202222928106.0
Nov. 9, 2022 (CN) 202222989400.2
Nov. 15, 2022 (CN) 202223038810.5
Dec. 19, 2022 (CN) 202223413732.2
Feb. 8, 2023 (CN) 202320231044.X
Feb. 16, 2023 (CN) 202320295274.2
Apr. 17, 2023 (CN) 202320882604.8
Apr. 17, 2023 (CN) 202320958823.X

(51) Int. Cl. F04D 25/08; F04D 25/06; F04D 27/00; F04D 29/046; F04D 29/048; H02K 11/33

(52) U.S. Cl. CPC F04D 25/084; F04D 25/0673; F04D 25/0693; F04D 27/00; F04D 29/0465; F04D 29/0467; F04D 29/048; H02K 11/33

(57) ABSTRACT

A portable fan includes a fan and a power supply drive assembly electrically connected to the fan. The power supply drive assembly includes a battery and a fan drive circuit electrically connected to the battery; the fan drive circuit includes: a master control circuit; and a three-phase drive circuit, including at least three signal input ends and three drive signal output ends. Each of the at least three signal input ends is electrically connected to the master control circuit to receive control signals; each of the three drive signal output ends is electrically connect to a respective one of three signal ends of a fan motor to respectively output the three-phase drive signal to drive the fan motor to rotate. The battery is configured to supply power to the fan drive circuit.

### CROSS REFERENCE TO RELATED APPLICATIONS

The present application is a continuation application of the U.S. patent application Ser. No. 18/927,186, filed on Oct. 25, 2024, which is a continuation-in-part application of the international patent application No. PCT/CN2023/099539, filed on Jun. 9, 2023.

The international patent application No. PCT/CN2023/099539 claims priorities of: the Chinese Patent application No. 202221176136.4, filed on May 11, 2022; the Chinese patent application No. 202221486507.9, filed on Jun. 14, 2022; the Chinese patent application No. 202221950040.9, filed on Jul. 25, 2022; the Chinese patent application No. 202222795438.6, filed on Oct. 21, 2022; the Chinese patent application No. 202222918924.2, filed on Nov. 2, 2022; the Chinese patent application No. 202222928106.0, filed on Nov. 2, 2022; the Chinese patent application No. 202222989400.2, filed on Nov. 9, 2022; the Chinese patent application No. 202223038810.5, filed on Nov. 15, 2022; the Chinese patent application No. 202223413732.2, filed on Dec. 19, 2022; the Chinese patent application No. 202320231044.X, filed on Feb. 8, 2023; the Chinese patent application No. 202320295274.2, filed on Feb. 16, 2023; the Chinese patent application No. 202320882604.8, filed on Apr. 17, 2023; the Chinese patent application No. 202320958823.X, filed on Apr. 17, 2023.

Contents of the above documents are incorporated herein by their entireties.

### TECHNICAL FIELD

The present disclosure relates to the field of fans, and in particular to a portable fan, drive circuit, handheld fan, and neck fan.

### BACKGROUND

Fans are very commonly-used domestic appliances in daily lives and can drive air to flow for cooling. Portable fans currently in the art has a light weight and can be easily carried and are popular among people. However, for the portable fan in the art, due to having a small size and a light weight, an airflow speed generated by the fan may be low, and after a long-term use, heat is generated, which may lead to an explosion.

### SUMMARY OF THE DISCLOSURE

The present disclose provides a portable fan, including a fan and a power supply drive assembly electrically connected to the fan. The power supply drive assembly includes a battery and a fan drive circuit electrically connected to the battery; the fan drive circuit includes: a master control circuit; and a three-phase drive circuit, including at least three signal input ends and three drive signal output ends. Each of the at least three signal input ends is electrically connected to the master control circuit to receive control signals; each of the three drive signal output ends is electrically connect to a respective one of three signal ends of a fan motor to respectively output the three-phase drive signal to drive the fan motor to rotate. The battery is configured to supply power to the fan drive circuit.

### BRIEF DESCRIPTION OF THE DRAWINGS

The present disclosure will be illustrates based on embodiments by referring to the accompanying drawings. The accompanying drawings of the present disclosure are used only to describe the embodiments. Any ordinary skilled person in the art may easily obtain other embodiments based on the described operations without deviating from the principles of the present disclosure.

FIG. 1 is a circuit diagram of a master chip of a master control circuit of a fan drive circuit of the portable fan according to embodiments of the present disclosure.

FIG. 2 is a circuit diagram of a three-phase drive circuit and a current detection circuit of the fan drive circuit of the portable fan according to embodiments of the present disclosure.

FIG. 3 is a circuit diagram of an inverted-phase electric potential detection circuit of the fan drive circuit of the portable fan according to embodiments of the present disclosure.

FIG. 4 is a circuit diagram of an interface circuit and a charge management circuit of the fan drive circuit of the portable fan according to embodiments of the present disclosure.

FIG. 5 is a schematic view of an auxiliary chip of the master control circuit of the fan drive circuit of the portable fan according to embodiments of the present disclosure.

FIG. 6 is a circuit diagram of an indicator branch and a keypad of the fan drive circuit of the portable fan according to embodiments of the present disclosure.

FIG. 7 is a schematic view of a first speed regulating member of the fan drive circuit of the portable fan according to embodiments of the present disclosure.

FIG. 8 is a schematic view of a second speed regulating member of the fan drive circuit of the portable fan according to embodiments of the present disclosure.

FIG. 9 is a schematic view of the master control circuit of the fan drive circuit of the portable fan according to embodiments of the present disclosure.

FIG. 10 is a schematic view of the three-phase drive circuit and the current detection circuit of the fan drive circuit of the portable fan according to embodiments of the present disclosure.

FIG. 11 is a schematic view of the inverted-phase electric potential detection circuit of the fan drive circuit of the portable fan according to embodiments of the present disclosure.

FIG. 12 is a schematic view of a transistor temperature detection circuit of the fan drive circuit of the portable fan according to embodiments of the present disclosure.

FIG. 13 is a schematic view of a battery voltage detection circuit of the fan drive circuit of the portable fan according to embodiments of the present disclosure.

FIG. 14 is a schematic view of a burner interface of the fan drive circuit of the portable fan according to embodiments of the present disclosure.

FIG. 15 is a schematic view of the master chip of the master control circuit of the fan drive circuit of the portable fan according to embodiments of the present disclosure.

FIG. 16 is a schematic view of the three-phase drive circuit and the battery voltage detection circuit of the fan drive circuit of the portable fan according to embodiments of the present disclosure.

FIG. 17 is a schematic view of three three-phase control chips of the master control circuit of the fan drive circuit of the portable fan according to embodiments of the present disclosure.

FIG. 18 is a schematic view of a signal amplification circuit of the fan drive circuit of the portable fan according to embodiments of the present disclosure.

FIG. 19 is a schematic view of the transistor temperature detection circuit of the fan drive circuit of the portable fan according to embodiments of the present disclosure.

FIG. 20 is a schematic view of a light control circuit of the fan drive circuit of the portable fan according to embodiments of the present disclosure.

FIG. 21 is a schematic view of a Hall detection circuit of the fan drive circuit of the portable fan according to embodiments of the present disclosure.

FIG. 22 is a schematic view of a switch control circuit of the fan drive circuit of the portable fan according to embodiments of the present disclosure.

FIG. 23 is a schematic view of a direct current conversion circuit of the fan drive circuit of the portable fan according to embodiments of the present disclosure.

FIG. 24 is a schematic block view of the portable fan according to embodiments of the present disclosure.

FIG. 25 is a schematic view of a portion of a portable fan according to embodiments of the present disclosure.

FIG. 26 is a partial circuit diagram view of the portable fan according to the embodiments of the present disclosure.

FIG. 27 is a perspective view of the portable fan according to the embodiments of the present disclosure.

FIG. 28 is an exploded view of a portion of the portable fan shown in FIG. 27.

FIG. 29 is a perspective view of a portable fan according to a first implementation of embodiments of the present disclosure.

FIG. 30 is a cross-sectional view of a portion of the portable fan shown in FIG. 29.

FIG. 31 is a structural schematic view of a fan according to an Embodiment 13 of the present disclosure.

FIG. 32 is a structural schematic view of the fan, being viewed from another viewing angle, according to the Embodiment 13 of the present disclosure.

FIG. 33 is a structural schematic view of the fan, having partial elements omitted, according to the Embodiment 13 of the present disclosure.

FIG. 34 is a structural schematic view of the fan, having partial elements omitted, according to the Embodiment 13 of the present disclosure.

FIG. 35 is a structural schematic view of the fan, having partial elements omitted, according to the Embodiment 13 of the present disclosure.

FIG. 36 is a structural schematic view of the fan, having partial elements omitted, according to the Embodiment 13 of the present disclosure.

FIG. 37 is a cross-sectional view of a portion of the portable fan according to the Embodiment 13 of the present disclosure.

FIG. 38 is an enlarged view of a portion B shown in FIG. 37.

FIG. 39 is a cross-sectional view of a portion of the portable fan according to the Embodiment 13 of the present disclosure.

FIG. 40 is an enlarged view of a portion A shown in FIG. 39.

FIG. 41 is a structural schematic view of a fan according to embodiments of the present disclosure.

FIG. 42 is a structural schematic view of the fan, having partial structure omitted, according to embodiments of the present disclosure.

FIG. 43 is a structural schematic view of the fan, being viewed from another viewing angle, according to embodiments of the present disclosure.

FIG. 44 is a cross-sectional view of the fan according to embodiments of the present disclosure.

FIG. 45 is a cross-sectional view of the fan, being viewed from another viewing angle, according to embodiments of the present disclosure.

FIG. 46 is a cross-sectional view of the fan according to embodiments of the present disclosure.

FIG. 47 is a cross-sectional view of the fan, being viewed from another viewing angle, according to embodiments of the present disclosure.

FIG. 48 is a perspective view of a portable fan according to a technical solution 5 of the present disclosure.

FIG. 49 is a perspective view of the portable fan, being viewed from another viewing angle, according to the technical solution 5 of the present disclosure.

FIG. 50 is a cross-sectional view of the portable fan according to the technical solution 5 of the present disclosure.

FIG. 51 is an enlarged view of a portion A shown in FIG. 50.

FIG. 52 is a disassembled view of the support portion according to the embodiments of the present disclosure.

FIG. 53 is a partially disassembled view of the portable fan according to embodiments of the technical solution 5 of the present disclosure.

FIG. 54 is a schematic view of a side wall of a clamp arm being disassembled off, according to the embodiments of the present disclosure.

FIG. 55 is a partially disassembled view of the portable fan according to embodiments of the technical solution 5 of the present disclosure.

FIG. 56 is a disassembled view of a portion of the portable fan according to the technical solution 5 of the present disclosure.

FIG. 57 is a disassembled view of a rotatable connection member of the portable fan according to the technical solution 5 of the present disclosure.

FIG. 58 is a perspective view of a portable fan according to a technical solution 6 of the present disclosure.

FIG. 59 is a perspective view of the portable fan, being viewed from another viewing angle, according to the technical solution 6 of the present disclosure.

FIG. 60 is a cross-sectional view of the portable fan according to the technical solution 6 of the present disclosure.

FIG. 61 is an enlarged view of a portion A shown in FIG. 60.

FIG. 62 is a disassembled view of the support portion of the portable fan according to the technical solution 6 of the present disclosure.

FIG. 63 is a schematic view of a second side wall of the clamp arm being disassembled off, according to the technical solution 6of the present disclosure.

### DETAILED DESCRIPTION

In order to facilitate better understanding of purposes, structures, features and efficacies of the present disclosure, a portable fan of the present disclosure will be further described by referring to the accompanying drawings and specific embodiments.

Technical solutions in the embodiments of the present disclosure will be clearly and completely described below by referring to the accompanying drawings in the embodiments of the present disclosure. It is to be understood that the specific embodiments described herein are for the purpose of explaining the present disclosure only, and do not limit the present disclosure. It is also to be noted that, for the purpose of description, only partial structures related to the present disclosure, instead of all structures, are shown in the accompanying drawings. Based on the embodiments of the present disclosure, all other embodiments obtained by any ordinary skilled person in the art without creative work shall fall within the scope of the present disclosure.

The terms “first”, “second”, and so on, in the present disclosure are used to distinguish between different objects and are not used to describe a particular order. In addition, the terms “includes”, “have”, and any variations thereof, are intended to cover non-exclusive inclusion. For example, a process, a method, a system, a product, or an apparatus including a series of steps or units is not limited to the listed steps or units, but optionally further includes steps or units that are not listed or include steps or units that are inherently included in the process, the method, the system, the product, or the apparatus.

Reference to “embodiments” herein means that particular features, structures, or characteristics described in one embodiment may be included in at least one embodiment of the present disclosure. The presence of the phrase at various sections in the specification does not necessarily refer to one same embodiment or to a separate or alternative embodiment that is exclusive of other embodiments. It is understood by any ordinary skilled person in the art, both explicitly and implicitly, that the embodiments described herein may be combined with other embodiments.

It should be noted that when an element is described as being “fixed to” or “arranged” on another element, the element may be directly or indirectly on the another element. When an element is described as being “connected” to another element, the element may be directly or indirectly connected to the another element. The embodiments and features of the embodiments in the present disclosure may be combined with each other without conflict. The present disclosure will be described in detail below by referring to the accompanying drawings and the embodiments.

It is to understand that the terms “length”, “width”, “upper”, “lower”, “front”, “rear”, “left”, “right”, “vertical”, “horizontal”, “top”, “bottom”, “inside”, “outside” and the like indicate orientations or positional relationships based on those shown in the accompanying drawings, and are used to facilitate and simplify description of the present disclosure. The terms are not intended to indicate or imply that a device or an element must have a specific orientation or must be constructed and operated in a specific orientation. Therefore, the terms shall not be interpreted as a limitation of the present disclosure.

Furthermore, the terms “first” and “second” are used only for descriptive purposes, and shall not be interpreted as indicating or implying relative importance or implicitly specifying the number of technical features indicated. Therefore, a feature defined by “first” and “second” may expressly or implicitly include one or more such features. In the description of this application, “a plurality of” means two or more, unless otherwise expressly and specifically limited.

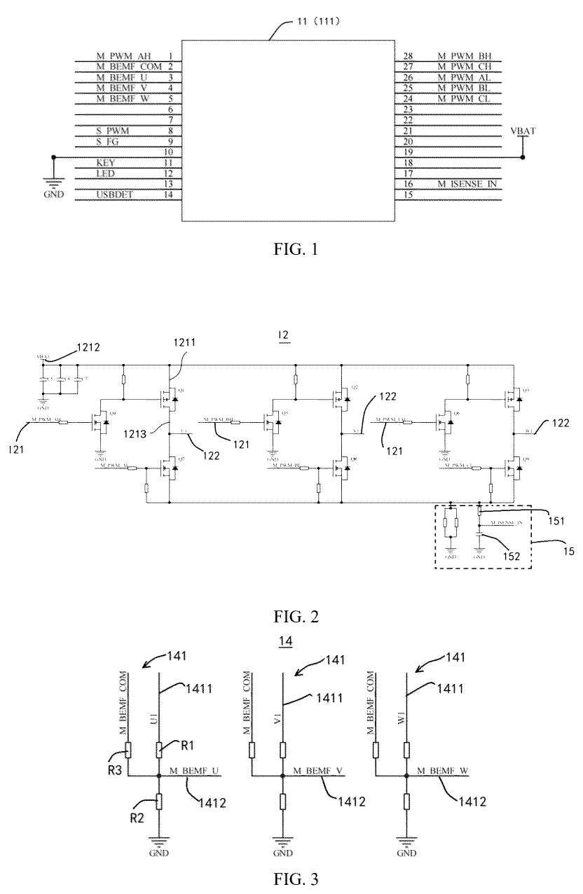

A technical solution 1 is shown in FIGS. 1 to 24.

As shown in FIGS. 1 to 3, the present embodiment provides a drive circuit for a portable fan. The fan drive circuit of the portable fan is applicable for various types of fans. Specifically, the drive circuit for the portable fan includes: a master control circuit 11, a three-phase drive circuit 12, and an inverted-phase electric potential detection circuit 14.

The three-phase drive circuit 12 includes at least three signal input ends 121 and three drive signal output ends 122. Each of the at least three signal input ends 121 is electrically connected to the master control circuit 11 to receive control signals. The three drive signal output ends 122 are electrically connect to three signal ends (U, V, and W) of a direct-current (DC) brushless fan motor to output a three-phase drive signal to drive the DC brushless fan motor to rotate. The inverted-phase electric potential detection circuit 14 includes three detection branches 141. Each detection branch 141 includes a detection end 1411 and a detection output end 1412 electrically connected to the detection end. Three detection ends 1411 of the three detection branches 141 are respectively electrically connected to the three drive signal output ends 122. Three detection output ends 1412 of the three detection branches 141 are electrically connected to the master control circuit 11 to respectively output a first detection signal, a second detection signal, and a third detection signal. In this way, the master control circuit 11 is informed of a phase of the three-phase drive signal based on the first detection signal, the second detection signal, and the third detection signal to adjust the control signals.

As shown in FIG. 3, the detection branch 141 includes a first detection resistor R1, a second detection resistor R2, and a third detection resistor R3. The first detection resistor R1 and the second detection resistor are connected to each other in series. An end of the first detection resistor R1 away from the second detection resistor R2 is the detection end 1411, and an end of the second detection resistor R2 away from the first detection resistor R1 is grounded. A node between the first detection resistor R1 and the second detection resistor R2 is the detection output end 1412.

By arranging the three-phase drive circuit 12, energy-saving performance and control performance of the fan motor are improved, and a service life of the fan drive circuit and the portable fan is extended. By arranging the inverted-phase electric potential detection circuit 14, the master control circuit 11 may be easily informed of the phase of the DC brushless fan motor, such that the master control circuit 11 may send corresponding control signals to the three-phase drive circuit 12 to control driving of the DC brushless fan motor, and reliability and stability of the driving is improved.

As shown in FIG. 2, the three-phase drive circuit 12 includes a first transistor Q1, a second transistor Q2, a third transistor Q3, a fourth transistor Q4, a fifth transistor Q5, a sixth transistor Q6, a seventh transistor Q7, an eighth transistor Q8, and a ninth transistor Q9. A first conductive end 1211 of the first transistor Q1, a first conductive end 1211 of the second transistor Q2, and a first conductive end 1211 of the third transistor Q3 are connected to a power supply end 1212. A first conductive end 1211 of the fourth transistor Q4 is connected to the power supply end 1212. A first conductive end 1211 of the fifth transistor Q5 is connected to the power supply end 1212. A first conduction end 1211 of the sixth transistor Q6 is connected to the power supply end 1212. A control end of the fourth transistor Q4, a control end of the fifth transistor Q5, and a control end of the sixth transistor Q6 are electrically connected to the master control circuit 11. A control end of the seventh transistor Q7 is electrically connected to the control end of the fourth transistor Q4, a control end of the eighth transistor Q8 is electrically connected to the control end of the fifth transistor Q5, and a control end of the ninth transistor Q9 is electrically connected to the control end of the sixth transistor Q6, such that the control signals are received. Second conduction ends 1213 of the fourth transistor Q4, the fifth transistor Q5, and the sixth transistor Q6 are grounded. A first conductive end 1211 of the seventh transistor Q7 is connected to a second conductive end 1213 of the first transistor Q1. A second conductive end 1213 of the seventh transistor Q7 is grounded. A first conductive end 1211 of the eighth transistor Q8 is connected to a second conductive end 1213 of the second transistor Q2. A second conductive end 1213 of the eighth transistor Q8 is grounded. A first conductive end 1211 of the ninth transistor Q9 is connected to the second conductive end 1213 of the third transistor Q3. A second conductive end 1213 of the ninth transistor Q9 is grounded. A node between the first conductive 1211 of the seventh transistor Q7 and the second conductive 1213 of the first transistor Q1, a node between the first conductive 1211 of the eighth transistor Q8 and the second conductive 1213 of the second transistor Q2, and a node between the first conductive 1211 of the ninth transistor Q9 and the second conductive 1213 of the third transistor Q3 respectively serve as the three drive signal output ends 122. The at least three signal input ends 121 are three PWM signal input ends. The control signals include three PWM signals.

As shown in FIG. 2, the fan drive circuit further includes a current detection circuit 15. The second conductive ends 1213 of the seventh transistor Q7, the eighth transistor Q8, and the ninth transistor Q9 are all grounded via the current detection circuit 15. The current detection circuit 15 is electrically connected to the master control circuit 11. The current detection circuit 15 includes a sense resistor 151 and a sense capacitor 152. The second conductive ends 1213 of the seventh transistor Q7, the eighth transistor Q8, and the ninth transistor Q9 are grounded via the sense resistor 151 and the sense capacitor 152 sequentially. A node between the sense resistor 151 and the sense capacitor 152 is electrically connected to the master control circuit 11. By arranging the current detection circuit 15, when a current is abnormal, the master control circuit 11 may control the fan drive circuit to stop operating or to operate at a lower power, such that an overcurrent protection is provided for the fan drive circuit, and reliability and the service life of the fan drive circuit are improved.

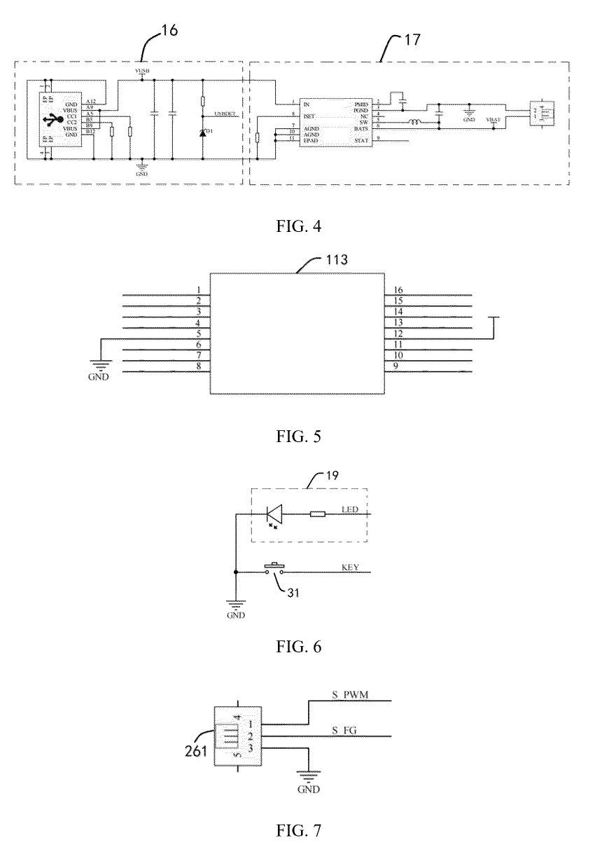

As shown in FIGS. 4 and 6, the fan drive circuit further includes an interface circuit 16 and a charge management circuit 17. The interface circuit 16 is configured to be electrically connected to an external power source to receive an external voltage. The charge management circuit 17 is electrically connected between the interface circuit 16 and a battery VBAT to receive the external voltage and to charge or output a power supply voltage to the battery VBAT. The fan drive circuit further includes a keypad 31. An end of the keypad 31 is connected to the master control circuit 11, and the other end of the keypad 31 is grounded. The fan drive circuit further includes an indicator branch 19. The indicator branch 19 includes a light-emitting diode and a resistor that is connected in series to the light-emitting diode. A positive electrode of the light-emitting diode is electrically connected to the master control circuit 11, and a negative electrode of the light-emitting diode is grounded.

Specifically, in the present embodiment, the fan drive circuit may be arranged for a neck fan and a handheld fan, but is not limited to the neck fan and the handheld fan, the fan drive circuit may further be applied to other portable fans such as desktop table fans, floor fans, clip fans, folding fans, and the like. Two DC brushless fan motors are respectively arranged in a left side and a right side of the neck fan and are configured to respectively drive fan blades in the left side and fan blades in the right side of the neck fan to rotate.

As shown in FIGS. 1, 2, and 5, the master control circuit 11 includes a master control chip 111 and an auxiliary chip 113. The master control circuit 11 includes the master control chip 111 and the auxiliary chip 113. Two three-phase drive circuits 12, two inverted-phase electric potential detection circuits 14, and two DC brushless fan motors are arranged in one-to-one correspondence to each other. The master control chip 111 is electrically connected to one of the two three-phase drive circuits 12 to output the control signals to one of the two three-phase drive circuits 12 to drive the respective one of the two brushless DC fan motors. The inverted-phase electric potential detection circuit 14 is electrically connected to one three-phase drive circuit 12 and outputs the first detection signal, the second detection signal, and the third detection signal to the master control chip 111. In this way, the master control chip 111 is informed of the phase of the three-phase drive signal of the one three-phase drive circuit 12 to adjust the control signals output to the one three-phase drive circuit 12. The auxiliary chip 113 is electrically connected to the other three-phase drive circuit 12 to output the control signals to the other three-phase drive circuit 12 to drive the other one of the two DC brushless fan motors. The other inverted-phase electric potential detection circuit 14 is electrically connected to the respective one three-phase drive circuit 12 and outputs a corresponding first detection signal, a corresponding second detection signal and a corresponding third detection signal to the auxiliary chip 113. In this way, the auxiliary chip 113 is informed of the phase of the three-phase drive signal of the other three-phase drive circuit 12 to adjust the control signals output to the other three-phase drive circuit 12.

In this embodiment, the master control chip 111, the corresponding three-phase drive circuit 12, and the corresponding inverted-phase electric potential detection circuit 14 are arranged on one module (such as on a first circuit board) and may be arranged on a same side of the neck fan as the corresponding DC brushless fan motor. The auxiliary chip 113, the corresponding three-phase drive circuit 12, and the corresponding inverted-phase electric potential detection circuit 14 are arranged on another one module (such as on a second circuit board that is independent from the first circuit board) and may be arranged on the other side of the neck fan, together with the corresponding DC brushless fan motor. It is understood that the above configuration has better rationality and compactness, and reliability of connection and driving is improved. However, arrangement of the three-phase drive circuit 12, the inverted-phase electric potential detection circuit 14, the master control chip 111, and the auxiliary chip 113 may be arranged in various manners. For example, the three-phase drive circuit 12, the inverted-phase electric potential detection circuit 14, the master control chip 111, and the auxiliary chip 113 are arranged on a same circuit board; alternatively, the three-phase drive circuit 12 and the inverted-phase electric potential detection circuit 14 are arranged on one circuit board, and the master control chip 111 and the auxiliary chip 113 are arranged on another one circuit board. The arrangement may be determined according to the actual demands, which will not described here.

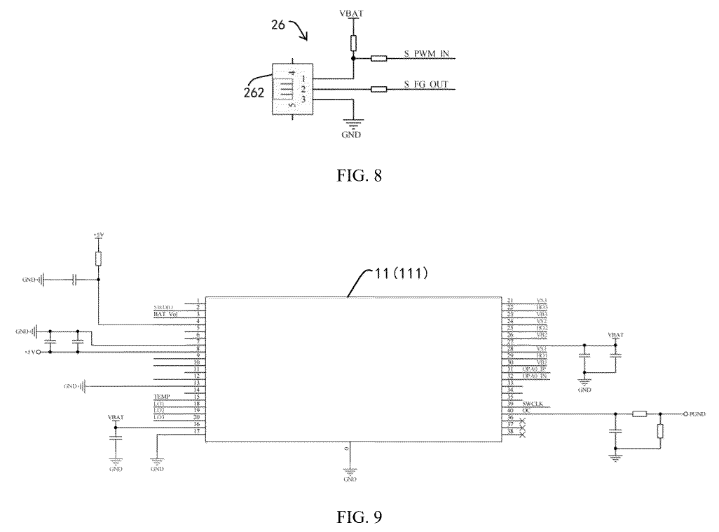

As shown in FIGS. 7 and 8, the fan drive circuit further includes a first connector 261 and a speed adjustment interface circuit 26 having a second connector 262. A first pin and a second pin of the first connector 261 are electrically connected to the master control chip 111. A third pin of the first connector 261 is grounded. A first pin of the second connector 262 is connected to the battery VBAT via a first connection resistor and is also connected to the auxiliary chip 113 via a second connection resistor. A second pin of the second connector 262 is connected to the auxiliary chip 113 via a third connection resistor, and a third pin of the second connector 262 is grounded. In addition, each pin of the first connector 261 and the second connector 262 may be electrically connected to each other in one-to-one correspondence with each other. In this way, rotation speeds of the two DC brushless fan motors may be synchronously adjusted.

As shown in FIGS. 9 to 14, the fan drive circuit of a second embodiment is shown. Portions of the fan drive circuit of the present embodiment are the same as those in the first embodiment and will not be repeated. Portions of the fan drive circuit of the present embodiment that are different from those in the first embodiment will be described in the following. Firstly, the master control circuit 11 of the present embodiment is different from that of the first embodiment, and the master control circuit 11 of the present embodiment may substantially include the master control chip 111.

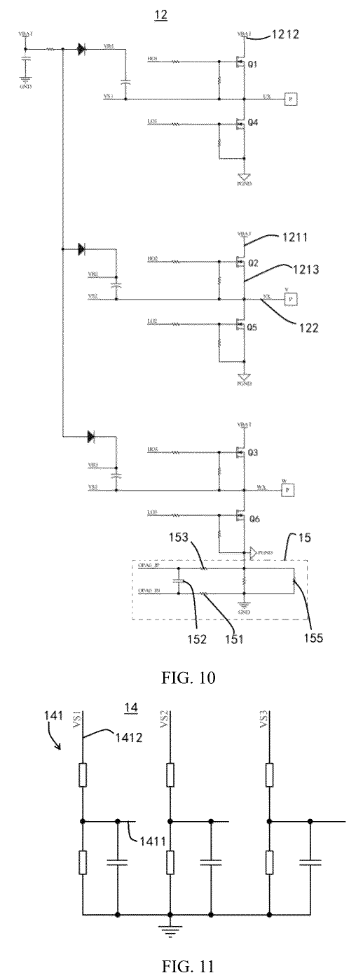

As shown in FIG. 10, in the present embodiment, the three-phase drive circuit 12 includes a first transistor Q1, a second transistor Q2, a third transistor Q3, a fourth transistor Q4, a fifth transistor Q5, and a sixth transistor Q6. A first conductive end 1211 of the first transistor Q1, a first conductive end 1211 of the second transistor Q2, and a first conductive end 1211 of the third transistor Q3 are connected to a power supply end 1212. A first conductive end 1211 of the fourth transistor Q4 is connected to a second conductive end 1213 of the first transistor Q1. A first conductive end 1211 of the fifth transistor Q5 is connected to a second conductive end 1213 of the second transistor Q2. A first conduction end 1211 of the sixth transistor Q6 is connected to a second conductive end 1213 of the third transistor Q3. A node between the first conductive 1211 of the fourth transistor Q4 and the second conductive 1213 of the first transistor Q1, a node between the first conductive 1211 of the fifth transistor Q5 and the second conductive 1213 of the second transistor Q2, and a node between the first conductive 1211 of the sixth transistor Q6 and the second conductive 1213 of the third transistor Q3 respectively serve as the three drive signal output ends 122. Control ends of the first transistor Q1, the second transistor Q2, the third transistor Q3, the fourth transistor Q4, the fifth transistor Q5, and the sixth transistor Q6 are electrically connected to the master control circuit 11 to receive the control signals; and the control signals include six PWM signals.

As shown in FIG. 10, substantially the same as the first embodiment, the second conductive end 1213 of the sixth transistor Q6 is grounded via the current detection circuit 15, and the current detection circuit 15 is electrically connected to the master control circuit 11. The current detection circuit 15 includes a sense resistor 151 and a sense capacitor 152. The second conductive end 1213 of the sixth transistor Q6 is grounded via the sense resistor 151. The sense capacitor 152 is connected in parallel with the sense resistor 151. A node between the sense resistor 151 and the second conduction end 1213 of the sixth transistor Q6 is electrically connected to the master control circuit 11. The current detection circuit 15 further includes a first series resistor 153, a second series resistor 154, a parallel resistor 155. The parallel resistor 155 is connected in parallel with the sense resistor 151. The first series resistance 153 is connected between an end of the sense capacitor 152 and an end of the sense resistor 151. The second series resistance 154 is connected between the other end of the sense capacitor 152 and the other end of the sense resistor 151. By arranging the current detection circuit 15, when the current is abnormal, the master control circuit 11 may control the fan drive circuit to stop operating or to operate at a lower power, such that an overcurrent protection is provided for the fan drive circuit, and reliability and the service life of the fan drive circuit are improved.

As shown in FIG. 11, the inverted-phase electric potential detection circuit 14 of the second embodiment is substantially the same as that of the first embodiment, and will not be repeated herein.

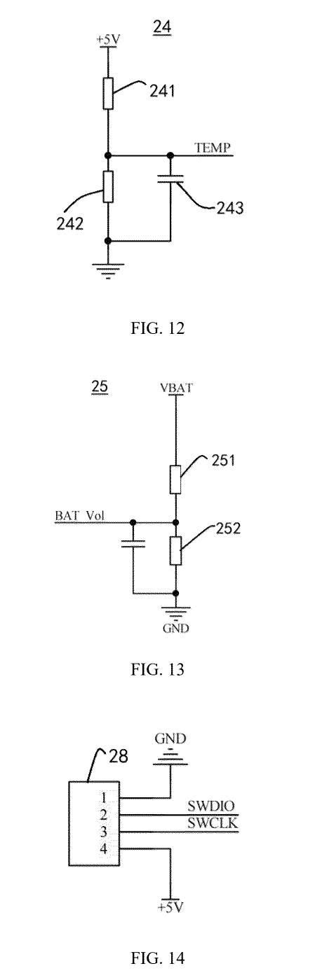

As shown in FIG. 12, the fan drive circuit further includes a transistor temperature detection circuit 24. The transistor temperature detection circuit 24 may be disposed adjacent to each transistor of the three-phase drive circuit 12 and includes a first voltage divider resistor 241 and a thermistor 242 connected in series with the first voltage divider resistor 241. The thermistor 242 is configured to sense a temperature of each transistor of the three-phase drive circuit 12. A node between the first voltage divider resistor 241 and the thermistor 242 is electrically connected to the master control circuit 11 and is configured to output a temperature signal, enabling the master control circuit 11 to control, based on the temperature signal, the fan drive circuit to enter or not enter a temperature protection state. The thermistor 242 is connected between the first voltage divider resistor 241 and the ground. The transistor temperature detection circuit 24 further includes a voltage regulated capacitor 243 connected in parallel with the thermistor 242. By arranging the transistor temperature detection circuit 24, the master control circuit 11 may be informed whether the temperature of each transistor of the three-phase drive circuit 12 is abnormal and may control the fan drive circuit to stop operating or to operate at a lower power when the temperature is abnormal. In this way, an over-temperature protection is provided for the fan drive circuit, and reliability and the service life of the fan drive circuit are improved.

As shown in FIG. 13, the fan drive circuit further includes a battery voltage detection circuit 25 that is electrically connected between the positive electrode of the battery VBAT and the ground. An output end of the battery voltage detection circuit 25 is electrically connected to the master control circuit 11. By arranging the battery voltage detection circuit 25, the master control circuit 11 may be informed whether a battery voltage is normal or not. When the battery voltage is abnormal, the master control circuit 11 may control the fan drive circuit to stop operating or to operate at a lower power. Therefore, reliability and the service life of the fan drive circuit are improved.

Specifically, the battery voltage detection circuit 25 includes a second voltage divider resistor 251 and a third voltage divider resistor 252 that is connected in series to the second voltage divider resistor 251. A node between the second voltage divider resistor 251 and the third voltage divider resistor 252 is electrically connected to the master control circuit 11. It is understood that the above-described battery voltage detection circuit 25 is simple in structure and has high reliability and a low cost.

As shown in FIG. 14, the fan drive circuit of the second implementation further includes a burner interface 28 to burn in a control program to the master control circuit 11. The burner interface 28 may be a SWD burner interface, but is not limited to the above.

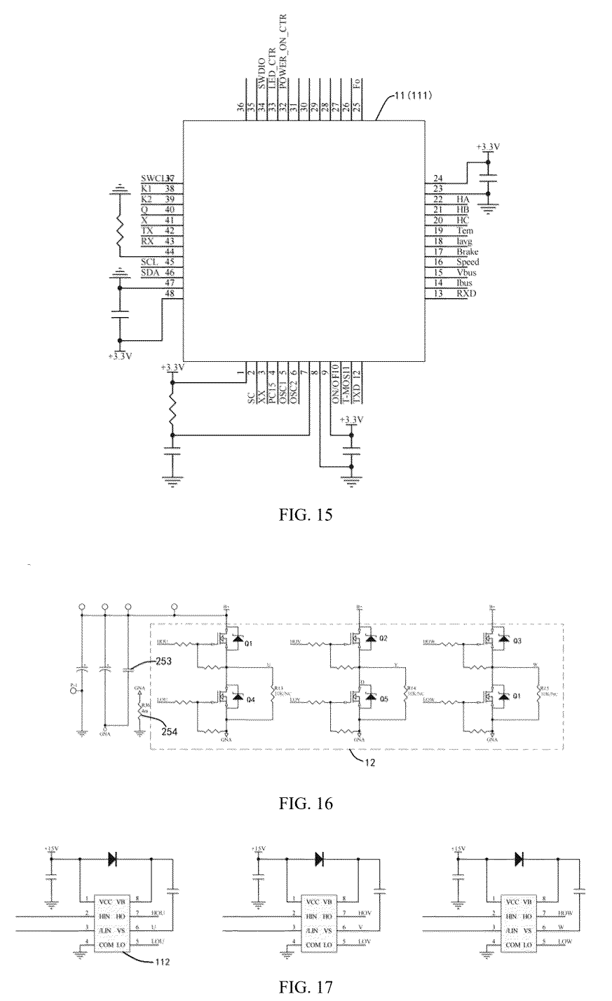

As shown in FIGS. 15 to 16, the fan drive circuit of a third embodiment is provided. Portions of the fan drive circuit of the present embodiment are the same as those in the second embodiment and will not be repeated. Portions of the fan drive circuit of the present embodiment that are different from those in the second embodiment will be described in the following.

As shown in FIG. 16 to FIG. 17, the three-phase drive circuit 12 of the third embodiment is essentially the same as the three-phase drive circuit 12 of the second embodiment. The master control circuit 11 of the third embodiment is different from that of the second embodiment. In the present embodiment, the master control circuit 11 includes a master control chip 111 and three three-phase control chips 112. Each of the three three-phase control chips 112 is electrically connected to the master control chip 111 and the three-phase drive circuit 12.

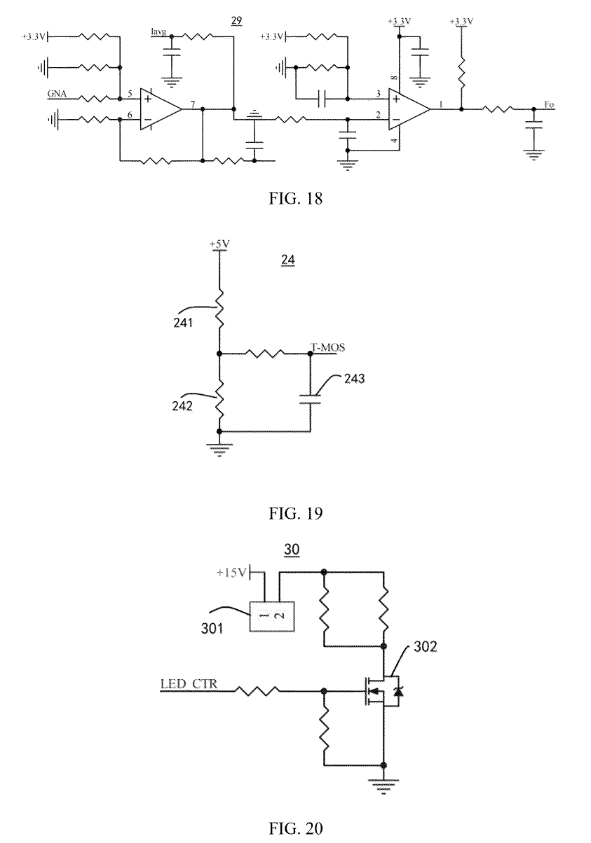

As shown in FIGS. 16 and 18, the fan drive circuit further includes a filter capacitor 253 and a sampling resistor 254 connected in series to the filter capacitor 253. The sampling resistor 254 is connected between the filter capacitor 253 and the ground. A node between the filter capacitor 253 and the sampling resistor 254 is electrically connected to the master control circuit 11. Further, the fan drive circuit further includes a signal amplification circuit 29. An input end of the signal amplification circuit 29 is connected to the node between the filter capacitor 253 and the sampling resistor 254. The signal amplification circuit 29 is configured to amplify a signal sampled by the sampling resistor 254 (i.e., a signal of the node between the filter capacitor 253 and the sampling resistor 254) and to provide the amplified signal to the master control circuit 11. In this way, the main control circuit 11 of the fan drive circuit may keenly detect an abnormal voltage or current signal when the fan drive circuit is abnormal and then perform protection against the abnormalities, such as stopping operating or reducing a fan speed. In this way, safety of using the fan drive circuit is improved.

As shown in FIG. 19, the transistor temperature detection circuit 24 of the third embodiment is essentially the same as that of the second embodiment and will not be repeated herein.

As shown in FIG. 20, a schematic view of a light control circuit 30 of the fan drive circuit in the third embodiment is provided. The light control circuit 30 includes a light-emitting element 301 and a control switch 302. A positive electrode of the light-emitting element 301 receives a drive voltage. A negative electrode of the light-emitting element 301 is grounded via two conductive ends of the resistor and the control switch 302. A control end of the control switch 302 is electrically connected to the master control circuit 11, such that the master control circuit 11 outputs a light control signal to the control end of the control switch 302 to control the light-emitting element 301 to emit light.

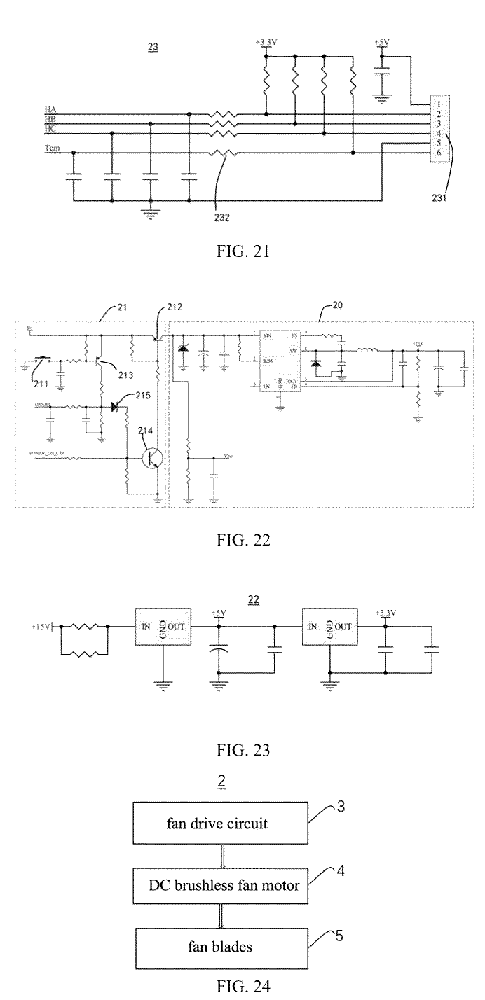

As shown in FIG. 21, the fan drive circuit further includes a Hall detection circuit 23. The Hall detection circuit 23 is electrically connected to the master control circuit 11 to detect a magnetic field generated by the DC brushless fan motor and to output a Hall detection signal to the master control circuit 11. In this way, the master control circuit 11 may be informed, based on the Hall detection signal, of a position of a rotor of the DC brushless fan motor, such that the master control circuit 11 may provide a corresponding control signal to control the DC brushless fan motor to operate. In this case, a start-up time length of the fan using the fan drive circuit is shorter, and the fan may not shake during starting-up, and a better user experience is provided.

As shown in FIG. 21, the Hall detection circuit 23 further includes a motor temperature detection element 232 connected between a Hall element 231 of the Hall detection circuit 23 and the master control circuit 11. The motor temperature detection element 232 may be a sampling resistor. By arranging the motor temperature detection element 232, the master control circuit 11 may be informed of whether a temperature of the DC brushless fan motor is abnormal. When the temperature of the DC brushless fan motor is abnormal, the master control circuit 11 may control the fan drive circuit to stop operating or operate at a lower power, such that an over-temperature protection is provided for the fan drive circuit, and reliability and the service life of the fan drive circuit are improved.

As shown in FIGS. 17 and 22, the fan drive circuit further includes a voltage conversion circuit 20. The voltage conversion circuit 20 is configured to receive a battery voltage (VB+), convert the battery voltage into a drive voltage (such as 15V), and provide the drive voltage to power supply ends of the three three-phase control chips 112. The master control chip 111 is configured to output a master control signal to the three three-phase control chips 112, such that each of the three three-phase control chips 112 outputs the respective control signal to the three-phase drive circuit 12.

The fan drive circuit further includes a switch control circuit 21. The switch control circuit 21 is electrically connected to the battery VBAT, the voltage conversion circuit 20, and the master control circuit 11 to control operation of the voltage conversion circuit 20. The switch control circuit 21 includes a keypad 211, a first switch transistor 212, a second switch transistor 213, and a third switch transistor 214. Two conductive ends of the first switch transistor 212 are respectively connected to the positive electrode of the battery VBAT and the input end of the voltage conversion circuit 20. A control end of the first switch transistor 212 is grounded via two conductive ends of the third switch transistor 214. The positive electrode of the battery VBAT is connected to the control end of the third switch transistor 214 via the two conductive ends of the first switch transistor 212 and a one-way diode 215. A control end of the second switch transistor 213 is grounded via the keypad 211. A control end of the third switch transistor 214 is electrically connected to the master control circuit 11. A node between the second switch transistor 213 and the one-way diode 215 is further electrically connected to a switch signal end of the master control circuit 11.

When the keypad 211 is pressed to be conductive, the second switch transistor 213 is turned on, the third switch transistor 214 is turned on, and the node between the second switch transistor 213 and the one-way diode 215 outputs a first switching signal (ON) to the switch signal end of the master control circuit 11. The first switch transistor 212 is turned on to enable the battery voltage of the battery VBAT to be supplied to the voltage conversion circuit 20. When the pressing on the keypad 211 is released, the second switch transistor 213 is turned off, the master control circuit 11 maintains the third switch transistor 214 to be turned on based on a power supply turn-on signal being output from the first switching signal to the control end of the third switch transistor 214, and the battery voltage of the battery VBAT is supplied to the voltage conversion circuit 20.

Further, when the battery voltage of the battery VBAT is supplied to the voltage conversion circuit 20, and when the keypad 211 is again pressed to be conductive, the node between the second switch transistor 213 and the one-way diode 215 outputs a second switching signal (OFF) to the switch signal end of the master control circuit 11, the master control circuit 11 controls the third switch transistor 214 to be turned off based on a power supply turn-off signal being output from the second switching signal to the control end of the third switch transistor 214. In this way, the first switch transistor 212 is turned off, the battery voltage of the battery VBAT cannot be supplied to the voltage conversion circuit 20 until the keypad 211 is again pressed.

The keypad 211, the first switch transistor 212, the second switch transistor 213 and the third switch transistor 214 operate together with the master control circuit 11 to control whether the battery voltage of the battery VBAT is supplied to the voltage conversion circuit 20. In this way, a simple control logic is provided, and the circuit has higher reliability.

As shown in FIG. 23, the fan drive circuit further includes a DC conversion circuit 22. The DC conversion circuit 22 is configured to receive the drive voltage (such as a DC voltage of 15V) and convert the drive voltage to other DC operating voltages, such as a DC operating voltage of 3.3V and 5V.

As shown in FIG. 24, the present disclosure further provides a portable fan 2. The portable fan 2 includes a fan drive circuit 3, a DC brushless fan motor 4, and fan blades 5 driven by the DC brushless fan motor. The fan drive circuit 3 may be arranged with the fan drive circuit as described in any of the above embodiments.

For the fan drive circuit and the portable fan 2 in the present embodiment, the master control circuit 11, the three-phase drive circuit 12, the inverted-phase electric potential detection circuit 14, and the DC brushless fan motor are arranged. The energy-saving performance and control performance of the fan motor are improved, such that reliability of the fan drive circuit and the fan 2 are improved. In addition, the service life of the fan drive circuit and the fan 2 is extended, the arrangement of the DC brushless fan motor allows the fan 2 to have a more compact and smaller configuration, and the fan 2 has increased competitiveness in the market.

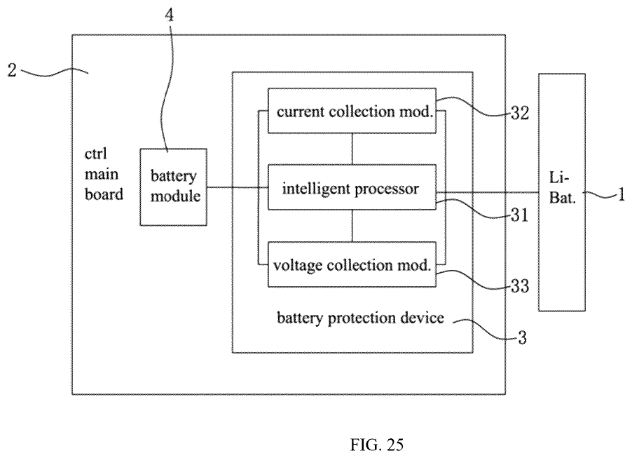

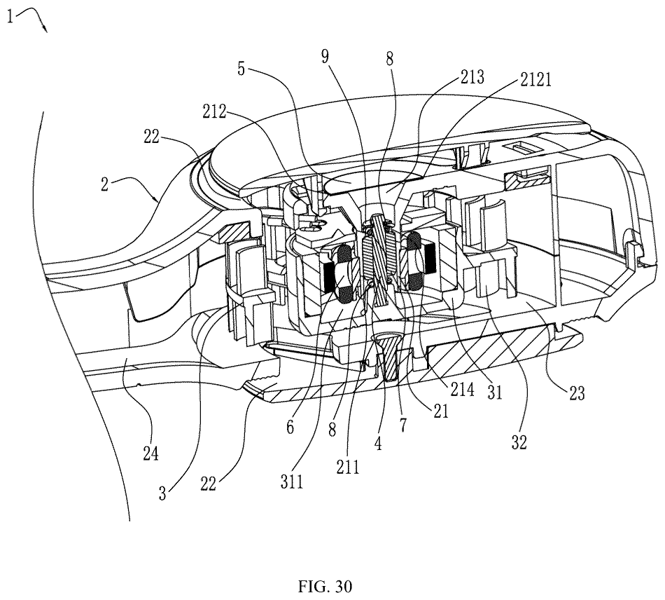

A technical solution 2 is shown in FIGS. 25 to 30.

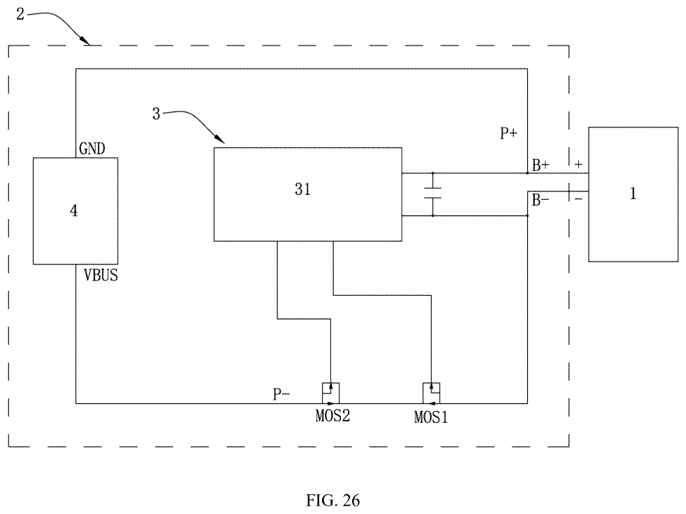

As shown in FIG. 25 and FIG. 26, a partial schematic view and a partial circuit diagram of the portable fan 100 of a first implementation are shown, where the partial schematic view and the partial circuit diagram are simplified. For example, a drive circuit between the control main board 2 and the fan assembly 6 is omitted. A battery protection device 3 usually includes pins B+, B−, P+ and P−. The battery protection device 3 usually includes an intelligent processor 31, a current collection module 32 and a voltage collection module 33. The intelligent processor 31 is connected to the current collection module 32 and the voltage collection module 33. The intelligent processor 31 may be an IC control chip, or other types of chips that are not limited herein. The voltage collection module 33 operates as follows. The pins B+ and B− of the battery protection device 3 are respectively connected to a positive electrode and a negative electrode of a lithium ion battery 1. In this way, the battery protection device 3 monitors a voltage between the positive electrode and the negative electrode of the lithium ion battery 1. The current collection module 32 operates as follows. A MOS1 and a MOS2 are connected to each other in series on a circuit, such that the MOS1 and the MOS2 monitor a current of the circuit.

The intelligent processor 31 monitors, by the voltage collection module 33 and the current collection module 32, the voltage of the lithium ion battery 1 and the current of the circuit to control the MOS1 and the MOS2 to be on or off. The MOS1 and the MOS2 serve as switches in the circuit to respectively control a charging circuit and a discharging circuit to be conducted or disconnected. During normal operation, when the voltage of the lithium ion battery 1 is within a range of A to B, both the MOS1 and the MOS2 are in an on state. When the intelligent processor 31 determines, based on a monitoring result of the voltage collection module 33, that the voltage of the lithium ion battery 1 reaches a value of B, the intelligent processor 31 controls the MOS1 (the charging circuit) to be off, such that the charging circuit is disconnected, and an external power source cannot charge the lithium ion battery 1. In this way, an overcharging protection is provided. When the intelligent processor 31 determines, based on the monitoring result of the voltage collection module 33, that the voltage of the lithium ion battery 1 is lower than a value of A, the intelligent processor 31 controls the MOS2 (the discharging circuit) to be off, such that the discharging circuit is disconnected, and the lithium ion battery 1 is not discharged to any load. In this way, a discharging protection is provided. During the lithium ion battery 1 being normally discharged to a load, a discharge current passes through the MOS1 and the MOS2 that are connected to each other in series. Due to a conduction impedance of the MOS1 and the MOS2, a voltage is generated at two ends of the MOS1 and the MOS2, and the intelligent processor 31 detects a value of the generated voltage. When the load is abnormal due to some reasons, resulting in the current of the circuit being increased, and when the current of the circuit is increased to enable the voltage between the ends of the MOS1 and the MOS2 to be greater than a value of C, the intelligent processor 31 controls the MOS1 and the MOS2 to be off, such that the discharging circuit is disconnected, the current of the circuit is turned to zero, and therefore, an overcurrent protection is provided. During the lithium ion battery 1 being discharged to the load, when the current of the circuit is increased to enable the voltage between the ends of the MOS1 and the MOS2 to be greater than a value of D (D>C), the intelligent processor 31 determines that the load is short-circuited and controls the MOS2 (the discharging circuit) to be off, such that the discharging is disconnected, and therefore, a short-circuit protection is provided. The current collection module 32 and the voltage collection module 33 are both connected to the lithium ion battery 1 to monitor the current and the voltage of the lithium ion battery 1. Since the intelligent processor 31, the current collection module 32, and the voltage collection module 33 operate together, the lithium ion battery 1 is prevented from overvoltage, undervoltage, overcurrent, and short circuits, such that an operation state of the lithium ion battery 1 is intelligently controlled.

The battery protection device 3 is arranged on the control main board 2. Therefore, when the lithium ion battery 1 needs to be disassembled, the lithium ion battery 1 can be directly removed from the portable fan 100, and another lithium ion battery 1 may be reassembled or replaced. In this way, disassembling and assembling of the battery protection device 3 with the lithium ion battery 1 can be reduced, facilitating inspection and replacement of the lithium ion battery 1.

As shown in FIGS. 25 to 26, the control main board 2 is arranged with a power supply module 4. The pins P− and P+ of the battery protection device 3 are respectively connected to pins of the power supply module 4, such that the current collection module 32 and the voltage collection module 33 are connected to the power supply module 4 to monitor a current and a voltage of the power supply module 4. Specifically, the power supply module 4 includes a charging interface 41, and in the present embodiment, the charging interface 41 is a TYPE-C female port. Of course, in other embodiments, the charging interface 41 may be a port in other connection types. During charging, pins VBUS and GND are respectively connected to the pins P− and P+ of the battery protection device 3, a conducted TYPE-C male terminal is inserted into the charging interface 41 to allow the charging interface 41 to intake power from an external power source. The charging interface 41 supplies power to the battery protection device 3 via the pins VBUS and GND, and the battery protection device 3, after being supplied with the power, charges power to the lithium ion battery via the pins B− and B+. During discharging, the lithium-ion battery 1, after being charged, supplies power to the control board 2 through the pins P− and P+ of the battery protection device 3. Therefore, a wire, which is connected between the lithium ion battery 1 and the control main board 2 for power supplying, can be eliminated. In this way, a circuit configuration of the portable fan 100 is simplified. The control main board 2 is further arranged with a switch 7 and a motor (not shown, the same hereinafter). The switch 7 is exposed outwardly to be operated by the user. Only when the switch 7 is turned on, the lithium ion battery 1 can supply power to the motor of the control main board 2. The motor drives the fan assembly 6 to rotate to activate the portable fan 100, otherwise, the portable fan 100 cannot be activated.

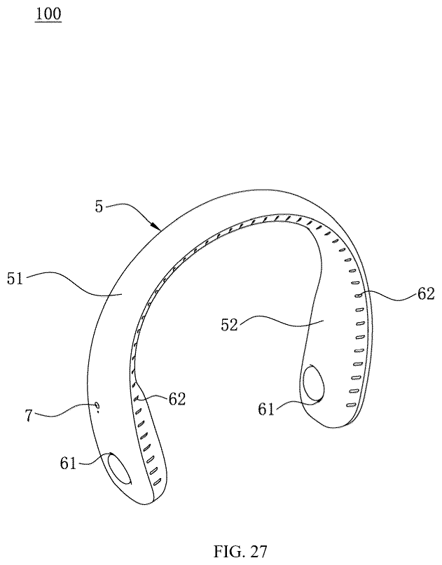

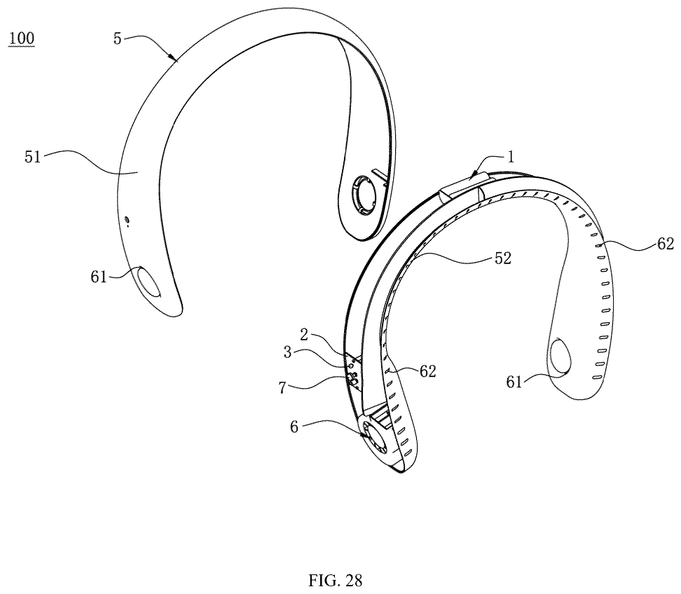

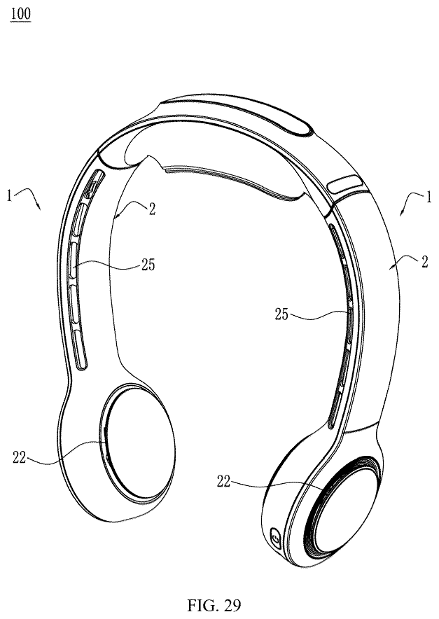

As shown in FIG. 27 and FIG. 28, wires between various components are also omitted in FIG. 28. The portable fan 100 is arranged with a housing 5, a fan assembly 6 arranged inside the housing 5, the lithium-ion battery 1 arranged inside the housing 5, the control main board 2 arranged inside the housing 5, and the battery protection device 3 arranged inside the housing 5. The housing 5 is arranged with an air inlet portion 61 and an air outlet portion 62. The housing 5 includes a first housing 51 and a second housing 52 mated with the first housing 51. The lithium ion battery 1 is configured to supply power to the portable fan 100. The fan assembly 6 rotates to intake air from the air inlet portion 61 and drives the air to be output from the air outlet portion 62. The control main board 2 is configured to control the portable fan 100. The battery protection device 3 is configured to protect the lithium ion battery 1. Further, the power supply module 4 is not shown in FIG. 28. It is to be understood that the power supply module 4 may also be arranged on the control main board 2. Other structures and functions of the present embodiment are the same as those in the first embodiment and will not be repeated herein.

Of course, the portable fan 100 is not limited to a portable fan, and the portable fans 100 applicable in other application scenarios fall within the scope of the present disclosure.

In summary, the portable fan 100 herein has the following beneficial effects:

The battery protection device 3 is arranged on the control main board 2, such that the lithium ion battery 1 can be directly removed from the portable fan 100 when the lithium ion battery 1 needs to be disassembled, and then another lithium ion battery 1 can be reassembled or replaced. Disassembling and assembling of the battery protection device 3 with the lithium ion battery 1 can be reduced, facilitating inspection and replacement of the lithium ion battery 1.

When the battery protection device 3 is electrically connected to the control main board 2, the battery protection device 3 may be integrated in the control main board 2, the wire between the battery protection device 3 and the control main board 2 can be eliminated, and space utilization is improved.

After charging, the lithium ion battery 1 supplies power to the control main board 2 through the pins P− and P+ of the battery protection device 3. Any wire, which is connected between the lithium ion battery 1 and the control main board 2 for power supplying, can be eliminated. In this way, a circuit configuration of the portable fan 100 is simplified.

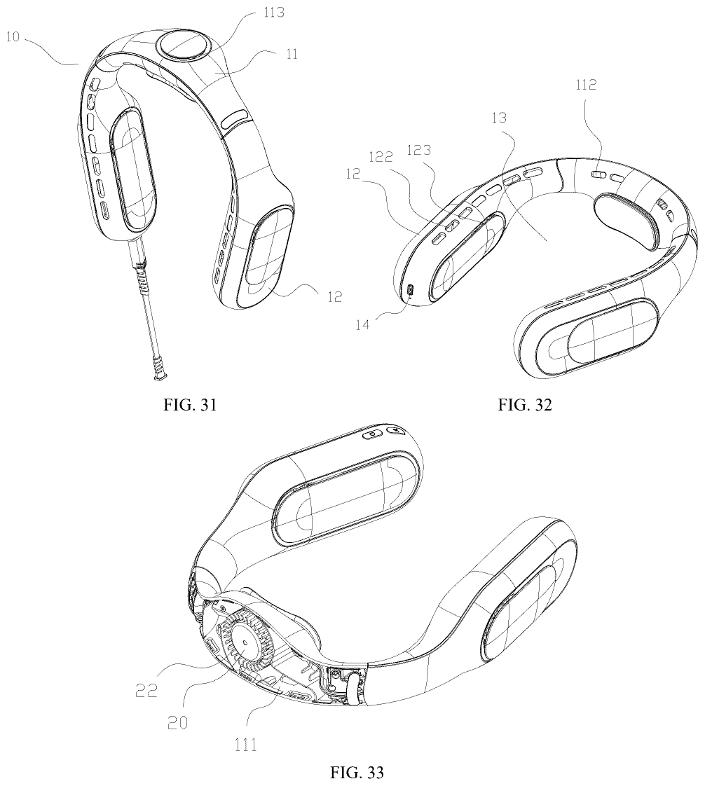

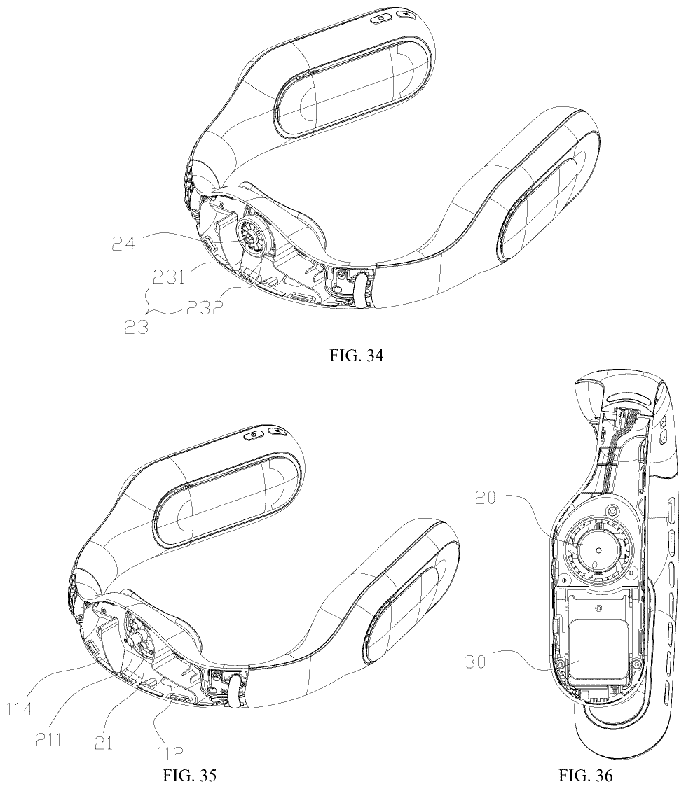

A technical solution 3 is shown in FIGS. 31 to 40.

As shown in FIGS. 31 to 40, in order to solve the above problem, the present disclosure provides a fan, including: a housing 10. The housing 10 includes a connection section 11 and two neck side sections 12 respectively connected to two sides of the connection section 11. The connection section 11 and the two neck side sections 12 cooperatively define a neck space 13. The connection section 11 and/or at least one of the two neck side sections 12 are arranged with an airflow portion 20. Each airflow portion 20 is configured to blow an airflow towards the neck space 13. In the present embodiment, since the two neck side sections are arranged respectively on the two sides of the connection section 11, the connection section 11 and the two neck side sections 12 cooperatively define the neck space 13, enabling the user to put on the fan through the neck space 13, and two hand of the user can be effectively freed. In addition, since the connection section 11 and/or the at least one of the two neck side sections 12 are arranged with the airflow portion 20, the fan of the present embodiment can blow the airflow towards the neck space 13, enabling the user to have a better airflow cooling experience.

For portable fans in the art, a single-phase motor is arranged for driving, an airflow strength is less, and a cooling effect is poor. Therefore, a better user experience cannot be provided.

As shown in FIGS. 31 to 40, in order to solve the above problem, the airflow portion 20 of the present embodiment includes a positioning protruding post 21, rotation air blades 22 and a three-phase motor drive assembly 23 that is driveably connected to the rotation air blades 22. The three-phase motor drive assembly 23 includes a stator 231 and a rotor 232 sleeving an outside of the stator 231. The rotor 232 is fixedly mounted on the rotation air blades 22 and is coaxially arranged with the rotation air blades 22. The stator 231 fixedly sleeves the positioning protruding post 21. By arranging the three-phase motor drive assembly 23 to drive the rotation air blades 22 in the present embodiment, the airflow portion 20 is enabled to output a stronger airflow to the neck space 13, such that the user may have an improved cooling effect.

As shown in FIGS. 33 to 35, in an embodiment, the airflow portion 20 is arranged on the connection section 11. The connection section 11 defines a first air guiding cavity 111 therein. The connection section 11 defines a first air outlet 112 communicated with the first air guiding cavity 111. The first air outlet 112 faces towards the neck space 13. The positioning protruding post 21 is received in the first air guiding cavity 111. The rotation air blades 22 are rotatably received in the first air guiding cavity 111 and configured to blow the airflow to the first air outlet 112.

In an embodiment, the rotation air blades are blades of a radial flow fan.

As shown in FIGS. 31 to 35, in an embodiment, in order to enable the fan of the present embodiment to effectively blow the air into the neck space 13, the connection section 11 defines a first air inlet 113 communicated to the first air guiding cavity 111, and the first air inlet 113 faces towards an end of the rotation air blades 22. The first air outlet 112 faces towards a side of the rotation air blades 22. By defining the first air inlet 113 facing towards the end of the rotation air blades 22 and defining the first air outlet 112 facing towards the side of the rotation air blades 22, the fan can efficiently drive the external ambient air to flow towards the neck space 13, such that the user can obtain a better cooling effect.

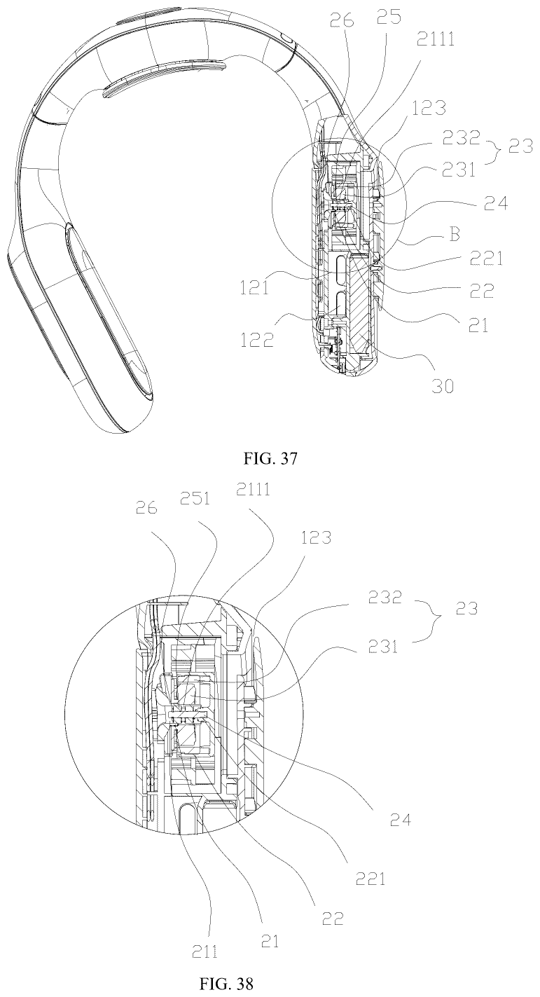

As shown in FIGS. 37 to 40, in an embodiment, the rotation air blades 22 defines a fixation hole 221, and an axis of the fixation hole 221 coincides with an axis of the rotation air blades 22. The airflow portion 20 further includes a rotation shaft 24. A first end of the rotation shaft 24 is fixedly threaded into the fixation hole 221. A positioning protruding post 21 defines a positioning hole 211. An axis of the positioning hole 211 coincides with the axis of the rotation shaft 24. A second end of the rotation shaft 24 is rotatably received in the positioning hole 211.

As shown in FIGS. 31 to 35, in order to improve the cooling effect of the fan provided in the present embodiment, a plurality of first air guiding ribs 114 are arranged in the connection section 11, and the plurality of first air guiding ribs 114 cooperatively define the first air guiding cavity 111. A plurality of first air outlets 112 are defined. The plurality of first air outlets 112 are spaced apart from each other and are located along an extension direction of the connection section 11. An end of the first air guiding cavity 111 is communicated with the plurality of first air outlets 112. The plurality of first air outlets 112 are defined, the plurality of first air outlets 112 are spaced apart from each other and are located along the extension direction of the connection section 11, and the end of the first air guiding cavity 111 is communicated with the plurality of first air outlets 112. Therefore, the air in the air guiding cavity can be uniformly output, by the airflow portion 20, from the plurality of first air outlets 112 to the neck space 13, such that the cooling effect of the fan is improved.

As shown in FIGS. 37 to 40, since the rotation air blades 22 of the present embodiment are driven by the three-phase motor assembly having a higher rotational speed, in order to avoid sharp wear between the rotation shaft 24 and the positioning hole 211 due to the high-speed rotation and to ensure the service life of the fan, at least one airflow portion 20 includes a bearing portion 25. An outer ring of the bearing portion 25 is fixed in the positioning hole 211, and an inner ring of the bearing portion 25 sleeves the second end of the rotation shaft 24. Due to the outer ring of the bearing portion 25 being fixed in the positioning hole 211 and the inner ring of the bearing portion 25 sleeving the second end of the rotation shaft 24, the friction between the positioning hole 211 and the rotation shaft 24 can be converted from sliding friction to friction inside the bearing portion 25. In this way, wear and tear between the positioning hole 211 and the rotation shaft 24 can be effectively avoided, the service life of the airflow portion 20 of the present embodiment is extended.

As shown in FIGS. 37 and 38, in an embodiment, the bearing portion 25 includes a rolling bearing 251. The airflow portion 20 further includes a limiting member 26. The limiting member 26 is mounted on the second end of the rotation shaft 24. The bearing portion 25 is disposed between the limiting member 26 and the first end of the rotation shaft 24. A plurality of bearing portions 25 are arranged. An inner flange 2111 is arranged on an inner wall of the positioning hole 211, and the inner flange 2111 is disposed between two adjacent bearing portions 25, such that the two adjacent bearing portions 25 are spaced apart from each other. By arranging the limiting member 26 on the second end of the rotation shaft 24 and arranging the inner flange 2111 on an inner wall of the positioning hole 211, the inner ring and the outer ring of the rolling bearing 251 of the present embodiment can be effectively limited, such that the rolling bearing 251 can be effectively mounted.

In an embodiment, the airflow portion 20 of the present embodiment further includes an elastic member. The elastic member of the present embodiment is disposed between the rotation air blades 22 and the rolling bearing 251 near the rotation air blades 22 and sleeves the rotation shaft 24. Two ends of the elastic member of the present embodiment respectively abut against the inner ring of the rolling bearing 251 and the rotation air blades 22. In this way, an elastic force, in a direction away from the air outlet, is applied on the inner ring of the rolling bearing 251. Due to the elastic member of the present embodiment, the rolling bearing 251 can be preloaded, such that the service life of the rolling bearing 251 is extended.

In an embodiment, the bearing portion 25 of the present embodiment is a ball bearing, and the lubricating oil is arranged in the ball bearing.

In an embodiment, the bearing portion 25 of the present embodiment is a ceramic bearing, and the lubricating oil is arranged in the ceramic bearing.

In an embodiment, the bearing portion 25 of the present embodiment is a magnetic levitation bearing.

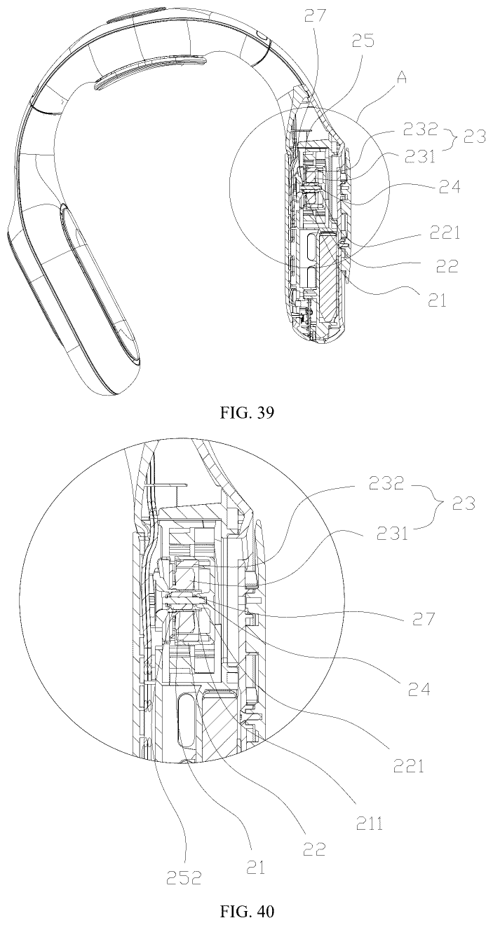

As shown in FIGS. 39 and 40, in another embodiment, the bearing portion 25 includes a slide bearing 252, and the airflow portion 20 further includes two sealing rings 27. The two sealing rings 27 both sleeve the rotation shaft 24 and are respectively located on two sides of the slide bearing 252. In the present embodiment, the slide bearing 252 between the rotation shaft 24 and the positioning hole 211, the inner ring of the slide bearing 252 is fixedly connected to the second end of the rotation shaft 24, and the outer ring is fixedly connected to the fixation hole 221. Therefore, the friction between the rotation shaft 24 and the positioning hole 211 can be converted into the friction between the inner ring and the outer ring of the slide bearing 252, wear and tear between the rotation shaft 24 and the positioning hole 211 is avoided, and the service life of the fan of the present embodiment is extended.

In an embodiment, the lubricate oil is arranged in the slide bearing 252. The sealing rings 27, which sleeve the rotation shaft 24 and are located on the two sides of the slide bearing 252 respectively, are configured to seal the lubricate oil.

As shown in FIGS. 36 to 40, in an embodiment, each of the two neck side sections 12 is arranged with one respective airflow portion 20. A second air guiding cavity 121 is defined in each neck side section 12. The neck side section 12 defines a second air outlet 122 communicated with the second air guiding cavity 121. The second air outlet 122 faces towards the neck space 13. The positioning protruding post 21 is received in the second air guiding cavity 121. The rotation air blades 22 are rotatably mounted in the second air guiding cavity 121 and are configured to blow the airflow to the second air outlet 122.

As shown in FIGS. 37 to 40, in an embodiment, the neck side section 12 defines a second air inlet 123 communicated to the second air guiding cavity 121. The second air inlet 123 faces an end of the rotation air blades 22, and the second air outlet 122 faces a side of the rotation air blades 22.

In an embodiment, a plurality of second air outlets 122 are defined. The plurality of first air outlets 122 are spaced apart from each other and are located along an extension direction of the neck side section 12.

In an embodiment, the airflow portion 20 is arranged in one of the two neck side sections 12, and the airflow portion 20 is arranged with the bearing portion 25.

In an embodiment, the airflow portion 20 is arranged in one of the connection section 11 and the two neck side sections 12, and the airflow portion 20 is arranged with the bearing portion 25.

In an embodiment, each of the connection section 11 and the two neck side sections 12 is arranged with one airflow portion 20 respectively, and the airflow portion 20 is arranged with the bearing portion 25.

As shown in FIG. 32 and FIG. 36, in order to enable the fan of the present embodiment to operate without being connected to any external power source, the fan further includes a power supply portion 30, arranged inside the housing 10. The power supply portion 30 is electrically connected to each airflow portion 20. The housing 10 is arranged with a charging port 14 that is electrically connected to the power supply portion 30. By arranging the power supply portion 30 in the housing 10 and enabling the power supply portion 30 to be electrically connected to each airflow portion 20, the fan of the present embodiment can blow the airflow without being connected to any external power source, such that application versatility of the fan of the present embodiment is improved. In addition, by arranging the charging port 14 in the housing 10 to be electrically connected to the power supply portion 30, the power supply portion 30 may be connected to the external power source through the charging port 14, such that the power supply section 30 can be charged.

In an embodiment, the power supply portion 30 of the present embodiment is a storage battery.

In an embodiment, at least one of the first air inlet and the first air outlet is arranged with a filter mesh. By arranging the filter mesh on at least one of the first air inlet and the first air outlet, debris in the external environment can be effectively avoided from entering the fan.

In an embodiment, at least one of the second air inlet and the second air outlet is arranged with a filter mesh. By arranging the filter mesh on at least one of the second air inlet and the second air outlet, debris in the external environment can be effectively avoided from entering the fan.

In an embodiment, the fan of the present embodiment further includes a gel receiving portion. The gel receiving portion is detachably arranged in the first air guiding cavity and/or the second air guiding cavity. The gel receiving portion of the present embodiment is configured to hold a gel-type aroma agent. By arranging the gel-type aroma agent inside the gel receiving portion, the airflow blown by the fan may have an aroma odour, and a better user experience is provided.

In an embodiment, the gel receiving portion of the present embodiment includes a box body and a cover plate covering on the box body. The box body is detachably mounted in a first air guiding cavity. The box body defines a receiving chamber to receive the gel-type aroma agent. The cover plate assembly includes a first cover plate and a second cover plate. The first cover plate is detachably mounted on the box body, and the second cover plate is pivoted to the first cover plate. The first cover plate has a first opening, and the second cover plate has a second opening. The second cover plate has a covering state in which the second cover plate covers the entire first opening and has an open state in which the first opening and the second opening coincide with each other. By rotating the second cover plate, the second cover plate can be switched between the covering state and the open state.

In summary, the fan of the present embodiment has at least the following beneficial technical effect. Two neck side sections are respectively arranged on the two sides of the connection section 11, such that the connection section 11 and the two neck side sections 12 cooperatively define the neck space 13, enabling the user to put on the fan through the neck space 13, and the hands of the user are freed. In addition, the airflow portion 20 is arranged in the connection section 11 and/or the at least one neck side section 12, such that airflow can be blown towards the neck space 13, a better cooling effect is provided.

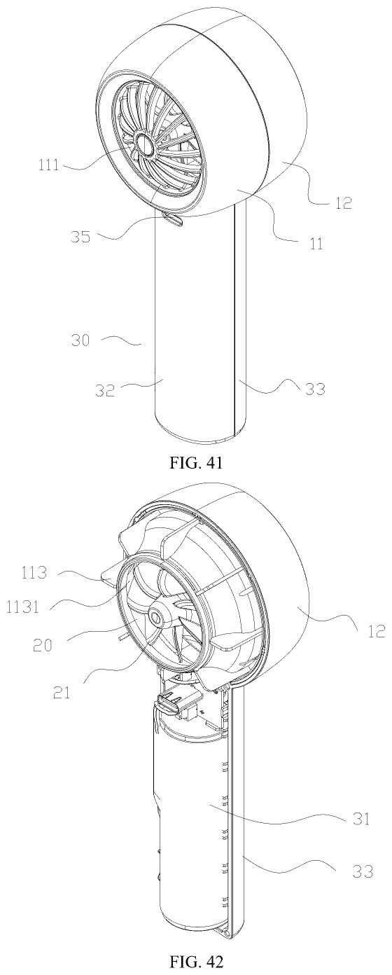

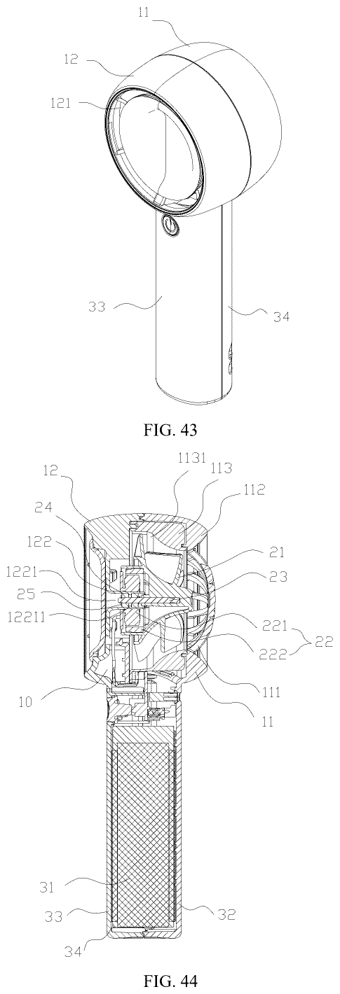

A technical solution 4 is shown in FIGS. 41 to 47.

As shown in FIG. 41 to FIGS. 47, in order to solve the above problem, the present disclosure provides a portable fan, including: an air duct portion 10, an airflow portion 20, a handheld portion 30. The air duct portion 10 includes a body portion, the body portion defines an air guiding cavity 13. The air duct portion 10 defines an air outlet 121 and an air inlet 111 respectively at two opposite ends thereof. The air outlet 121 and the air inlet 111 are both communicated to the air guiding cavity 13. A positioning protruding post 122 is arranged inside the body portion. The airflow portion includes rotation air blades 21 and a drive portion 22 that is drivably connected to the rotation air blades 21. The rotation air blades 21 are rotatably received in the air guiding cavity 13 and are arranged facing towards the air outlet 121. The drive portion 22 includes a stator 221 and a rotor 222 sleeving an outside of the stator 221. The rotor 222 is fixedly mounted on the rotation air blades 21 and is coaxially arranged with the rotation air blades 21. The stator 221 fixedly sleeves the positioning protruding post 122. The handheld portion 30 is connected to the air duct portion 10. The handheld portion 30 defines a mounting cavity 34. A power supply assembly 31 is received in the mounting cavity 34. The power supply assembly 31 is electrically connected to the drive portion 22. For the portable fan in the present embodiment, the drive portion 22, which is driveably connected to the rotation air blades 21, is configured as the stator 221 and the rotor 222 sleeving the outside of the stator 221. The rotor 222 is fixedly mounted on the rotation air blades 21 and is coaxially arranged with the rotation air blades 21. In addition, the stator 221 fixedly sleeves the positioning protruding post 122. In this way, a driving force generated by the drive portion 22 can be directly transmitted to the rotation air blades 21 through the rotor 222, a transmission member between the drive portion 22 and the rotation air blades 21 can be omitted. a transmission efficiency of the portable fan is improved. In an embodiment, the power supply assembly 31 is a storage battery.

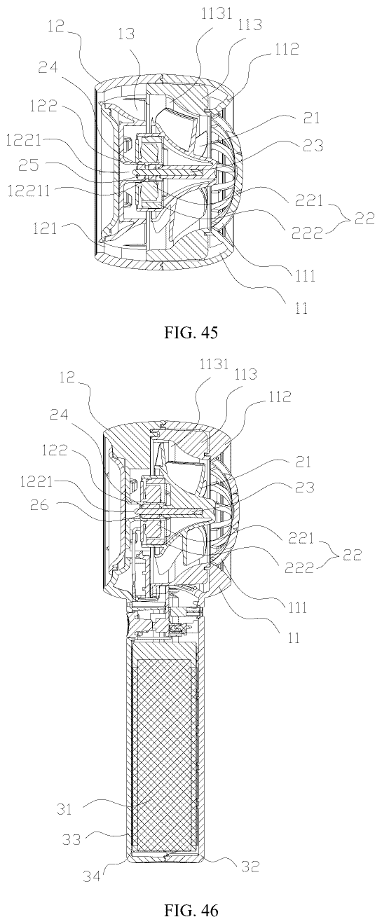

As shown in FIGS. 41 and 45, in an embodiment, the body portion includes a first housing 11 and a second housing 12 connected to the first housing 11. The air guiding cavity 13 is formed between the first housing 11 and the second housing 12. The first housing 11 defines the air inlet 111, the second housing 12 defines the air outlet 121. The positioning protruding post 122 is arranged on the second housing 12 and extends along an extension direction of the air guiding cavity 13.

As shown in FIGS. 44 to 47, in an embodiment, the rotation air blades 21 defines a fixation hole, an axis of the fixation hole coincides with an axis of the rotation air blades 21. The airflow portion 20 further includes a rotation shaft 23. A first end of the rotation shaft 23 is fixedly received in the fixation hole. A positioning hole 1221 is defined inside the positioning protruding post 122. An axis of the positioning hole 1221 coincides with an axis of the rotation shaft 23. A second end of the rotation shaft 23 is rotatably received in the positioning hole 1221.

As shown in FIGS. 44 to 47, in order to improve the service life of the portable fan provided in the present embodiment, the airflow portion 20 further includes a bearing portion 24. An outer ring of the bearing portion 24 is fixed in the positioning hole 1221, and an inner ring of the bearing portion 24 sleeves the second end of the rotation shaft 23. By disposing the bearing portion 24 between the positioning hole 1221 and the rotation shaft 23, and by receiving the outer ring of the bearing portion 24 in the positioning hole 1221 and arranging the inner ring to sleeve the second end of the rotation shaft 23, direct friction between the positioning hole 1221 and the rotation shaft 23 can be avoided, such that the service life of the portable fan is effectively improved.

As shown in FIGS. 44 and 45, in an embodiment, the bearing portion 24 includes a rolling bearing, and the airflow portion 20 further includes a limiting member 25. The limiting member 25 is mounted at the second end of the rotation shaft 23. The bearing portion 24 is disposed between the limiting member 25 and the first end of the rotation shaft 23. By arranging the limiting member 25 on the second end of the rotation shaft 23, a radial movement of the rolling bearing can be effectively limited.

As shown in FIGS. 44 and 45, in an embodiment, in order to facilitate mounting of the rolling bearing, a plurality of bearing portions 24 are arranged. An inner flange 12211 is arranged on an inner wall of the positioning hole 1221. The inner flange 12211 is disposed between two adjacent bearing portions 24 to enable the two adjacent bearing portions 24 to be spaced apart from each other. By arranging the limiting member 25 on the second end of the rotation shaft 23, the inner ring of the rolling bearing can be effectively limited. By arranging the inner flange 12211 on the inner wall of the positioning hole 1221, the outer ring of the bearing can be effectively limited. In this way, the rolling bearing can be mounted effectively.

In an embodiment, the bearing portion 24 is a ball bearing, and a lubricant is provided in the ball bearing.

In an embodiment, the bearing portion 24 is a ceramic bearing, and a lubricant is provided in the ceramic bearing.

In an embodiment, the bearing portion 24 is a magnetic levitation bearing.

In an embodiment, the airflow portion 20 further includes an elastic member, the elastic member sleeves the rotation shaft 23. Two ends of the elastic member respectively abut against the inner ring of the rolling bearing and the rotation air blades 21. The elastic member applies an elastic force on the inner ring of the rolling bearing in a direction away from the air inlet 111. By arranging the elastic member, the rolling bearing can be pre-tensioned, and the service life of the rolling bearing is effectively improved.

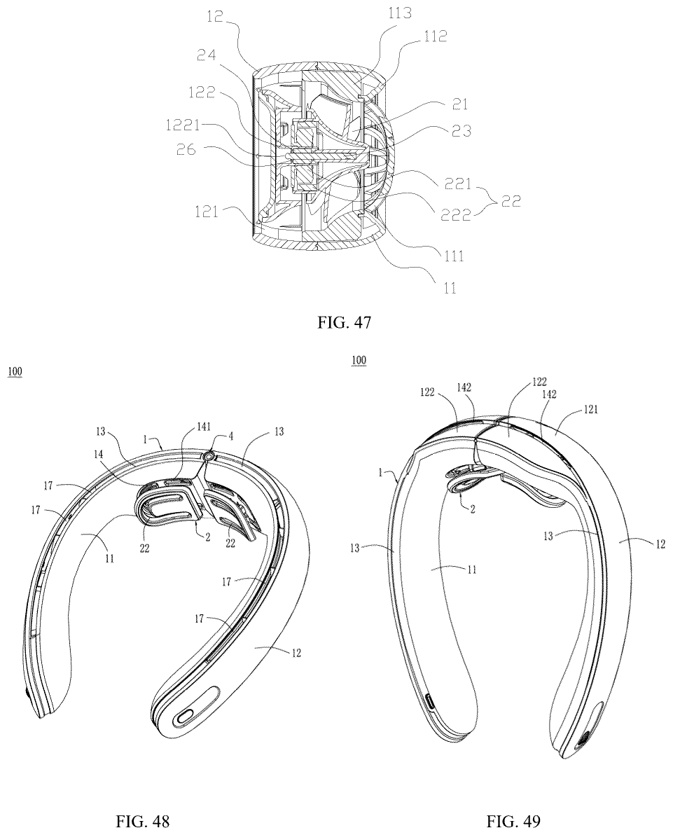

As shown in FIGS. 46 and 47, in an embodiment, in order to improve the service life of the portable fan of the present embodiment, the bearing portion 24 includes a slide bearing. The airflow portion 20 further includes two sealing rings 26. The two sealing rings 26 both sleeve the rotation shaft 23 and are respectively located on two sides of the slide bearing. By arranging the slide bearing between the rotation shaft 23 and the positioning hole, and by arranging the inner ring of the slide bearing to be fixedly connected to the second end of the rotation shaft 23 and arranging the outer ring to be fixedly connected to the fixation hole, friction between the rotation shaft 23 and the positioning hole 1221 can be converted into friction between the inner ring and the outer ring of the slide bearing. In this way, the friction between the rotation shaft 23 and the positioning hole 1221 is avoided, and the service life of the portable fan is effectively improved.

As shown in FIGS. 44 to 47, in an embodiment, the handheld portion 30 includes a third housing 32 and a fourth housing 33 connected to the third housing 32. The mounting cavity 34 is formed between the third housing 32 and the fourth housing 33.

As shown in FIGS. 44 to 47, in an embodiment, the first housing 11 includes a housing body 112 and an air duct liner 113. The air duct liner 113 is mounted on the housing body 112. The air duct 1131 is defined inside the air duct liner 113. The air guiding cavity 13 is formed between the air duct liner 113 and the second housing 12.

Since a single-phase motor is inexpensive, most of small-sized handheld portable fans on the market are driven by single-phase motors. However, since the single-phase motor has a low rotational speed, a strong airflow cannot be provided, and a poor user experience is provided. In order to enable the small-sized handheld portable fan to provide stronger airflow, a high-speed motor needs to be arranged for driving. However, the high-speed motor occupies a large space, and the portable fan may be worn and torn.

In order to solve the above problem, the drive portion 22 is a three-phase motor. Since the drive portion 22 is the three-phase motor, a rotation speed of the rotation air blades 21 can be effectively increased, and the portable fan in this embodiment can provide a stronger airflow, the user experience is improved. In addition, due to the high rotation speed of the three-phase motor, in order to avoid sharp wear between the rotation shaft and the positioning hole due to the high-speed rotation and to ensure the service life of the portable fan, in the portable fan of the present embodiment, a bearing portion is disposed between the positioning hole and the rotation shaft. The bearing portion enables the friction between the positioning hole and the rotation shaft to be converted from sliding friction to rolling friction inside the bearing portion, such that wear and tear between the positioning hole and the rotation shaft can be avoided, the service life of the portable fan is effectively improved.

As shown in FIGS. 41 to 47, in an embodiment, the handheld portion 30 is arranged with a charging port 35. The charging port 35 is electrically connected to the power supply assembly 31. By arranging the charging port 35 on the handheld portion 30 and enabling the charging port 35 to be electrically connected to the power supply assembly 31, the power supply assembly 31 can be electrically connected to an external power supply through the charging port 35, such that an operating endurance of the portable fan is ensured.

In an embodiment, a discharging port is arranged on the handheld portion that is electrically connected to the power supply assembly. The discharging port is electrically connected to an external electronic device. The discharging port enables electric power to be transmitted from the power supply assembly to the external electronic device.

In an embodiment, the air inlet is arranged with a grill assembly. The grill assembly includes a first grill member and a second grill member. The first grill member is fixedly connected to the first housing. The second grill member is pivotally connected to the first grill member. The first grill member defines a plurality of first openings. The second grill member defines a plurality of second openings. The plurality of first openings and the plurality of second openings are in one-to-one correspondence with each other. The second grill member has a shielding state that completely shields the first openings and an open state in which the first openings and the second openings overlap with each other. By rotating the second grill member, the second grill member can be switched between the shielding state and the open state. The grill assembly provided in this embodiment can effectively adjust the amount of air intaken from the air inlet, such that the user experience is effectively improved.

In an embodiment, the air duct portion 10 and the handheld portion 30 are fixedly connected to each other. Of course, in other embodiments, the air duct portion 10 and the handheld portion 30 may be pivotally connected to each other.

In an embodiment, the third housing 32 and the first housing 11 are integrally molded to form a one-piece structure, and the fourth housing 33 and the second housing 12 are integrally molded to form a one-piece structure

In another embodiment, the third housing 32 is pivotally connected to the first housing 11, and the fourth housing 33 is pivotally connected to the second housing 12. A pivot shaft between the third housing 32 and the first housing 11 is coaxial with a pivot shaft of the fourth housing 33 and the second housing 12.

In summary, the portable fan provided in the present embodiment has at least the following beneficial technical effect. The drive portion 22, which is driveably connected to the rotation air blades 21, is configured as the stator 221 and the rotor 222 sleeving the outside of the stator 221. The rotor 222 is fixedly mounted on the rotation air blades 21 and is coaxially arranged with the rotation air blades 21. In addition, the stator 221 fixedly sleeves the positioning protruding post 122. In this way, the driving force generated by the drive portion 22 can be directly transmitted to the rotation air blades 21 through the rotor 222, the transmission device between the drive portion 22 and the rotation air blades 21 is omitted, such that the transmission efficiency of the portable fan is improved.

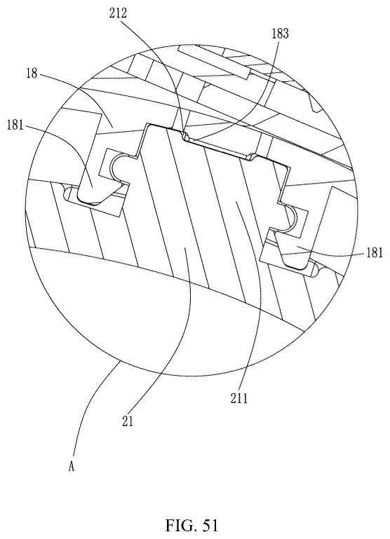

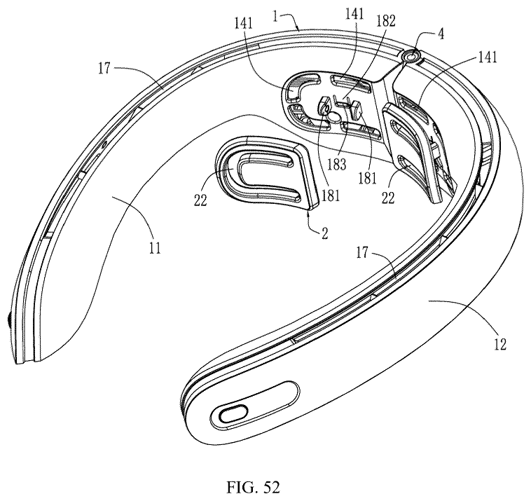

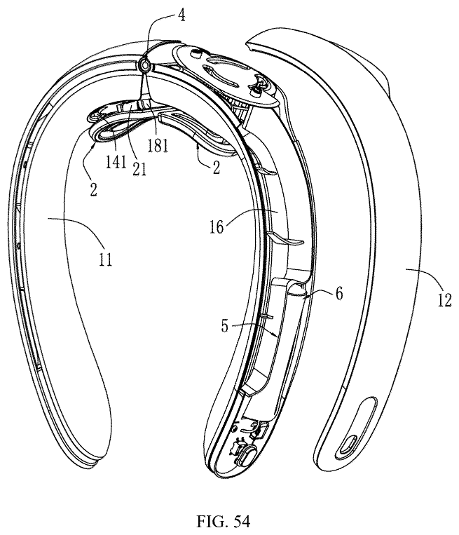

A technical solution 5 is shown in FIGS. 48-57.

As shown in FIGS. 48 to 51, schematic views of the portable fan 100 of the present disclosure are shown. The portable fan 100 includes a housing 1, a support member 2 and a fan assembly 3. The support member 2 is mounted on a side of the housing 1 facing the neck of the user. The support member 2 is rotatably connected to the housing 1 and is supported to the rear of the neck of the user. The fan assembly 3 is arranged inside the housing 1. By arranging the support member 2 to be supported to the rear of the neck, the housing 1 is prevented from rubbing the neck. In addition, the support member 2 supports the housing 1 and the rear of the neck of the user, allowing a spacing to be defined between the housing 1 and the rear of the neck, such that a contact area between the housing 1 and the neck is reduced, and a cooling effect of the portable fan 100 is improved.

As shown in FIGS. 48 to 50, the housing 1 includes a first side wall 11 facing towards the neck of the user and a second side wall 12 facing away from the neck of the user. A first mating portion 18 is arranged on and protrudes from the first side wall 11. The support member 2 is arranged with a second mating portion 21 corresponding to the first mating portion 18. The second mating portion 21 is rotatably connected to the first mating portion 18. The support member 2 is rotatable relative to the first side wall 11.

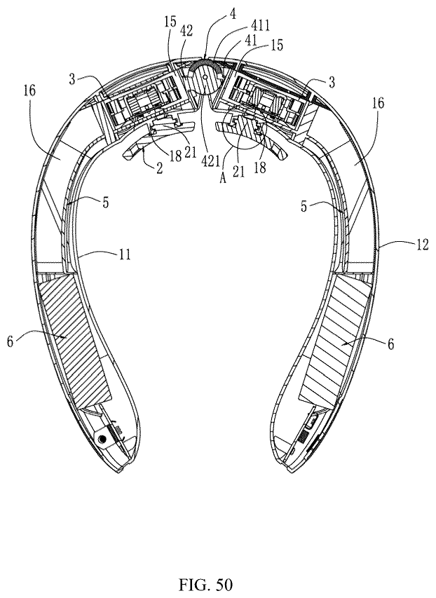

As shown in FIGS. 50 to 52, in the present embodiment, the first mating portion 18 includes two pivot portions 181 and an elastic arm 182 disposed between the two pivot portions 181. A protrusion 183 is arranged at a free end of the elastic arm 182. The second mating portion 21 includes a pivot column 211. A plurality of recesses 212 are defined in a surface of the pivot column 211. Two ends of the pivot column 211 are respectively pivotally connected to the two pivot portions 181. When the support member 2 is rotating upwardly and downwardly, the protrusion 183 is received in any one of the plurality of recesses 212 in order to position the support member 2 at various angles.

As shown in FIGS. 48 to 50, the housing 1 includes two clamp arms 13 that are disposed symmetrically to each other. The two the clamp arms 13 are rotatably connected to each other by a rotation connection member 4. A pivot angle of each clamp arm 13 is in a range of ±10°. The two clamp arms 13 are rotatably connected to each other to allow the user to adjust a distance between free ends of the two clamp arms 13, such that the portable fan can be worn to the neck and fixed. Each clamp arm 13 defines sequentially an air inlet 14, a receiving cavity 15, an air duct 16, and an air outlet 17, and the air inlet 14, the receiving cavity 15, the air duct 16, and the air outlet 17 are communicated to each other. The fan assembly 3 is received in the receiving cavity 15 to drive an airflow to flow from the air inlet 14 to flow through the air duct 16 to reach the air outlet 17.

As shown in FIGS. 48 to 50, the portable fan 100 is arranged with two support members 2 corresponding to the two clamp arms 13, respectively. When the two clamp arms 13 are pivoted, positions of the two support members 2 in contact with the user are changed. However, since the support members 2 are rotatably connected to the clamp arms 13, each support member 2 can be adjusted independently to be attached to the neck of the user, such that wearing comfort is improved.

As shown in FIGS. 48 to 50, corresponding to each of fan assembly 3, each clamp arm 13 defines a first air inlet 141 defined in the first side wall 11 and a second air inlet 142 defined in the second side wall 12. The receiving cavity 15 is located at two ends of the two clamp arms 13 that are connected to each other. The support member 2 is disposed corresponding to the receiving cavity 15. A spacing is defined between at least a portion of the support member 2 and the first air inlet 141. Therefore, when the portable fan 100 is in use, the support member 2 does not affect air intaken through the first air inlet 141. Moreover, as shown in FIG. 52, the support member 2 defines a through hole 22 corresponding to the first air inlet 141, such that sweat, generated by contact between the support member 2 and the neck, can be absorbed and evaporated in time, ensuring that the neck of the user is dry and fresh, and a wearing experience is improved.

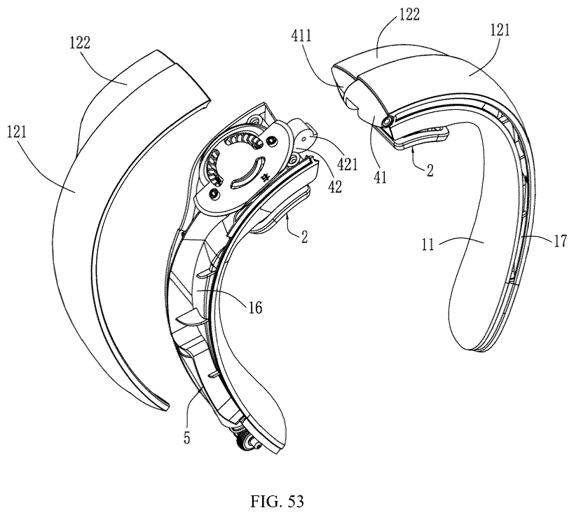

As shown in FIGS. 49 and 53, the second side wall 12 includes a main wall 121 and an auxiliary wall 122. The main wall 121 and the auxiliary wall 122 are arranged in a stepped manner. The second air inlet 142 is formed between the main wall 121 and the auxiliary wall 122. The second air inlet 142 is hiddenly formed between the main wall 121 and the auxiliary wall 122, and therefore, an aesthetic appearance is provided, and the hair of the user may not enter the second air inlet 142 easily, safety of the portable fan is improved. The main wall 121 is longer than the auxiliary wall 122. When the user is wearing the portable fan 100, the main wall 121 is located above the auxiliary wall 122, and the auxiliary wall 122 is located a radially inner side of the main wall 121. In this way, the second air inlet 142 defined in the second side wall 12 that faces away from the neck can be better hidden, and an opening of the second air inlet 142 faces downwards, such that the hair of the user may not be intaken into the air inlet easily. A cover plate having a through hole is disposed between the second air inlet 142 and the fan assembly 3. The cover plate having the through hole further prevents the hair from being sucked into the fan by the fan assembly 3.

As shown in FIGS. 50 and 53, the rotation connection member 4 includes a first connection member 41 and a second connection member 42. The first connection member 41 is fixedly connected to one of the two clamp arms 13, and the second connection member 42 is fixedly connected to the other one of the two clamp arms 13. The first connection member 41 includes a first fixation portion 411, and the second connection member 42 includes a second fixation portion 421. The first fixation portion 411 and the second fixation portion 421 are rotatably connected to each other. The first fixation portion 411 and the second fixation portion 421 cooperatively form a spindle shape. The two the clamp arms 13, during rotating, rotate along the first fixation portion 411 and the second fixation portion 421 that are configured in the spindle shape, such that an aesthetic appearance is provided.

As shown in FIGS. 50, 53 and 54, a partition assembly 5 is further arranged. The partition assembly 5 separates the receiving cavity 15 and the air duct 16, which are communicated with each other, from the other space inside the housing 1. A width of an end of the air duct 16 away from the receiving cavity 15 is less than a width of an end of the air duct 16 near the receiving cavity 15, such that a space is reserved to receive a battery 6. In the present embodiment, the battery 6 is arranged inside each of the two clamp arms 13, and two fan assemblies 3 may operate simultaneously or separately. The air outlet 17 is formed at and extends through a side of the air duct 16 and extends substantially to cover the entirety of the air duct 16. The width of the end of the air duct 16 away from the receiving cavity 15 is narrower, such that the air may be gathered easily at the narrower end, and various portions of the air outlet 17 may have an even airflow.

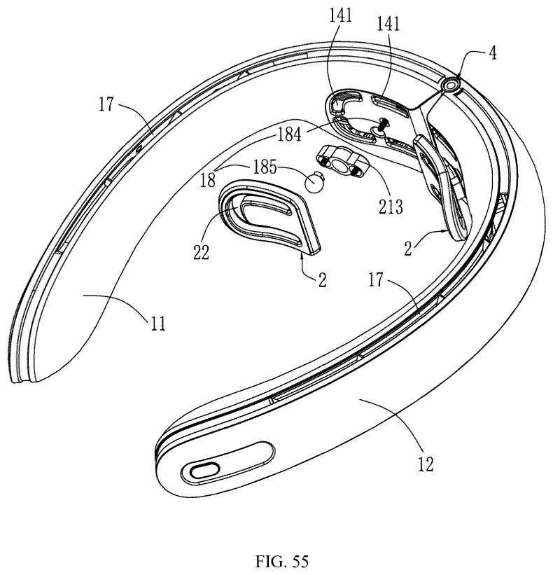

As shown in FIG. 55, a schematic view of the portable fan 100 of the present disclosure is shown. In the present embodiment, the second mating portion 21 includes a mounting bracket 213. The first mating portion 18 includes a fixation member 184 secured to the first side wall 11 and a rotation ball 185 that extends through the mounting bracket 213 and is secured to the fixation member 184. The mounting bracket 213 is rotated with respect to the rotation ball 185 to enable the support member 2 to rotate with respect to the rotation ball 185. The support member 2 may rotate up and down. In the present embodiment, the support member 2 may rotate spherically, such that the portable fan can be worn comfortably. Other structures and performance of the present embodiment are substantially the same as those in the above embodiments, and will not be repeated herein.

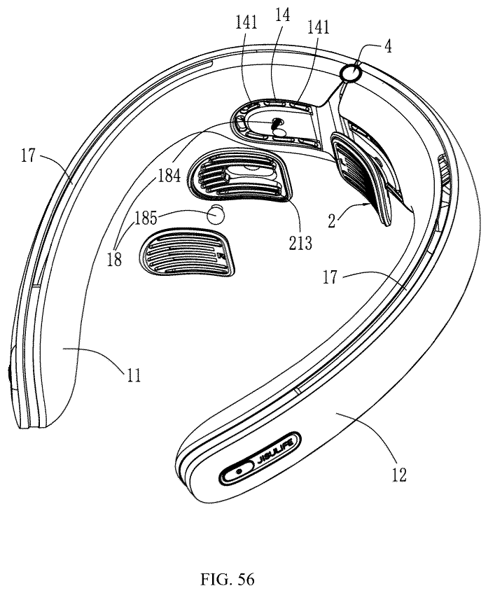

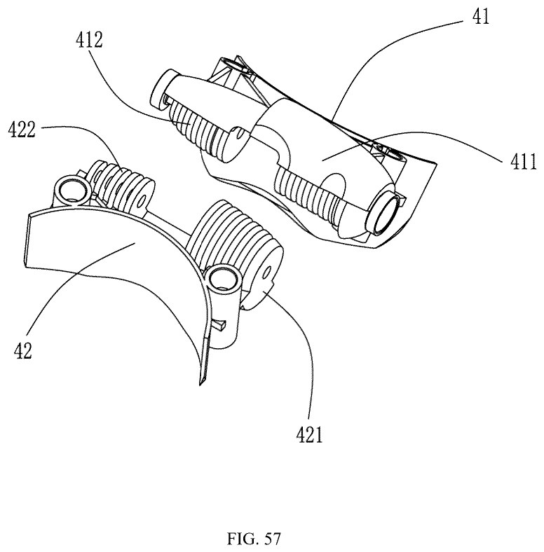

As shown in FIGS. 56 and 57, schematic views of the portable fan 100 of the present disclosure are shown. In the present embodiment, a shape of the mounting bracket 213 matches a shape of the second mating portion 21. In the rotation connection member 4, the first fixation portion 411 includes a plurality of first pieces 412, the second fixation portion 421 includes a plurality of second pieces 422. The plurality of the first pieces 412 and the plurality of the second pieces 422 are laminated and arranged alternately with each other. In this way, friction between the first fixation portion 411 and the second fixation portion 421 is greatly increased, such that, during rotating, the two clamp arms 13 may stop at any position, safety performance is improved. Other structures and performance of the present embodiment are substantially the same as those in the above embodiments, and will not be repeated herein.

It is understood that, in addition to the above embodiment, in other embodiments, the support member 2 is connected to the housing 1 by a bendable positioning member. The bendable positioning member may allow the support member 2 to be better attached to the rear of the neck.

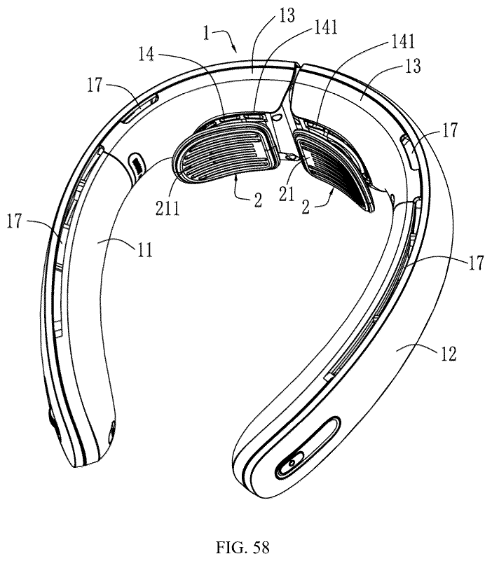

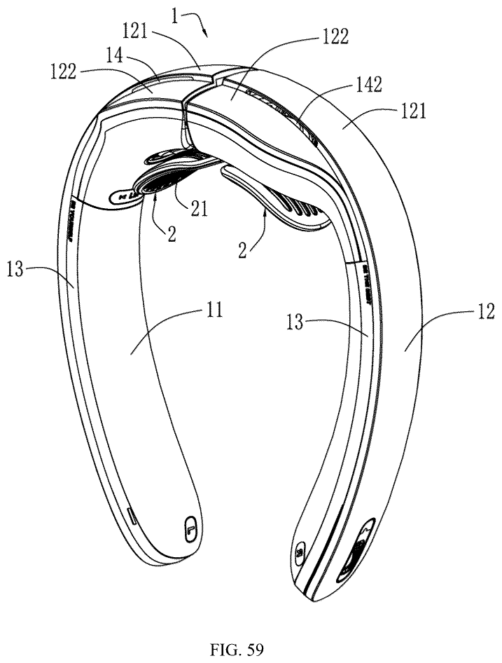

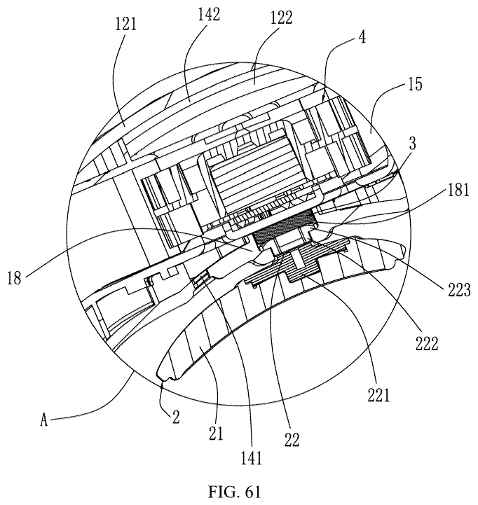

A technical solution 6 is shown in FIGS. 58-63.

As shown in FIGS. 58 to 61, schematic views of the portable fan of the present disclosure are shown. The portable fan includes a housing 1, a support member 2, a cushion member 3, and a fan assembly 4. The housing 1 is worn around the neck of the user. The housing 1 defines sequentially an air inlet 14, a receiving cavity 15, an air duct 16, and an air outlet 17; and the air inlet 14, the receiving cavity 15, the air duct 16, and the air outlet 17 are sequentially communicated to each other. The housing 1 is in a “C” shape. The housing 1 includes a rear neck section located at a middle of the housing. The receiving cavity 15 is defined in the rear neck section. The rear neck section is arranged with a mounting portion 18 at a position corresponding to the receiving cavity 15 and facing towards the rear of the neck. The support member 2 is mounted on the mounting portion 18 and is configured to support the rear neck of the user. The cushion member 3 is arranged inside the mounting portion 18 and abuts against the support member 2. The cushion member 3 may be elastically deformable. The fan assembly 4 is received in the receiving cavity 15 and is configured to drive the air to flow from the air inlet 14 through the air duct 16 to reach the air outlet 17.

By arranging the support member 2 to support the rear of the neck, the housing of the portable fan is prevented from directly touching the rear of the neck. In addition, the support member 2 is supported between the housing 1 to be away from the rear of the neck to allow a spacing to be defined between the housing 1 and the rear of the neck. In this way, a contact area between the housing 1 and the rear of the neck is reduced, a cooling effect of the portable fan is improved. The cushion member 3 is arranged in the mounting portion 18 to abut against the support member 2. Since the cushion member 3 is elastically deformable, the support member 2 is more flexible and is movable to be attached to necks of various users.

As shown in FIGS. 59 to 62, the housing 1 includes a first side wall 11 facing towards the neck of the user and a second side wall 12 facing away from the neck of the user. The first side wall 11 is arranged with the mounting portion 18. The support member 2 includes a contact portion 21 and a connection member 22. The contact portion 21 having a curved surface to be better attached to the neck. The connection member 22 includes a first mating portion 221 mating with the contact portion 21 and a second mating portion 222 mating with the mounting portion 18. Two second mating portions 222 are arranged. When the two second mating portions 222 are pressed, the two second mating portions 222 are moved close to each other to extend into or move out of the mounting portion 18. When pressing on the two second mating portions 222 is released, the two second mating portions 222 are secured to the mounting portion 18 or moved out of the mounting portion 18.

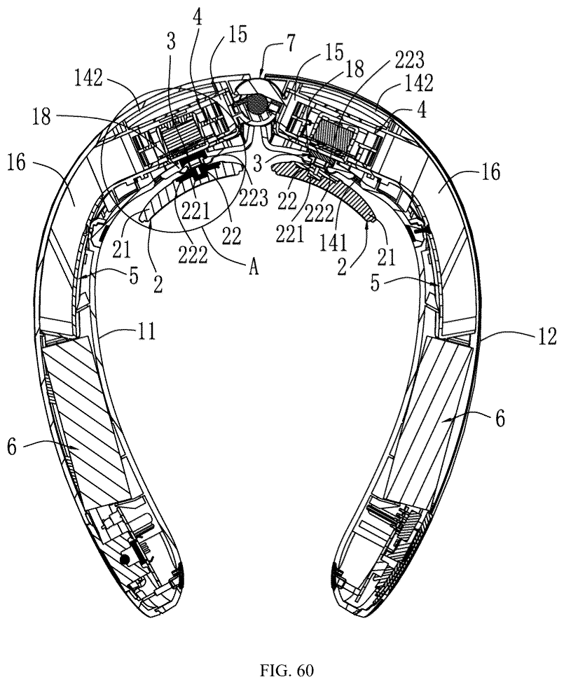

As shown in FIGS. 60 to 62, the mounting portion 18 includes a mounting cavity 181, the second mating portion 222 includes a hook portion 223 that enters the mounting cavity 181 and hooks with the mounting cavity 181. The cushion member 3 abuts against the hook portion 223. A height of the hook portion 223 and the cushion member 3 are greater than or equal to a height of the mounting cavity 181. In this way, the support member 2 may not be loosely shaken. The cushion member 3 is elastically deformable, and in the present embodiment, the cushion member 3 is made of silicone, and a size of the cushion member 3 may be compressed to be 15% to 25% of its original size. Therefore, the support member 2 is more flexible and can be better movable to be attached to necks of various users. Of course, in other embodiments, the cushion member 3 may be made of other materials having an elastic deformation capability. A spacing is formed between a surface of the first mating portion 221 facing towards the mounting portion 18 and the mounting portion 18, and the support member 2 may be flexibly rotated in all directions. Moreover, a mounting tool can access the spacing, such that the support member 2 can be mounted easily.

In the present embodiment, the support member 2 may be made of silicone. Properties of the silicone allow the support member 2 to be deformable, such that the support member 2 can be better attached to the neck. In addition, the silicone is more comfortable when being worn to the user, a better user experience is provided.

As shown in FIGS. 58 to 60, the housing 1 includes two clamp arms 13 that are disposed symmetrically to each other. The two clamp arms 13 are rotatably connected to each other by a rotation connection member 722. A pivot angle of each clamp arm 13 is in a range of ±10°. The two clamp arms 13 are rotatably connected to each other to allow the user to adjust a distance between free ends of the two clamp arms 13, such that the portable fan can be worn to the neck and fixed. Each clamp arm 13 defines sequentially an air inlet 14, a receiving cavity 15, an air duct 16, and an air outlet 17, and the air inlet 14, the receiving cavity 15, the air duct 16, and the air outlet 17 are communicated to each other. Two receiving cavities 15 are located close to each other and are both located at the rear neck section.

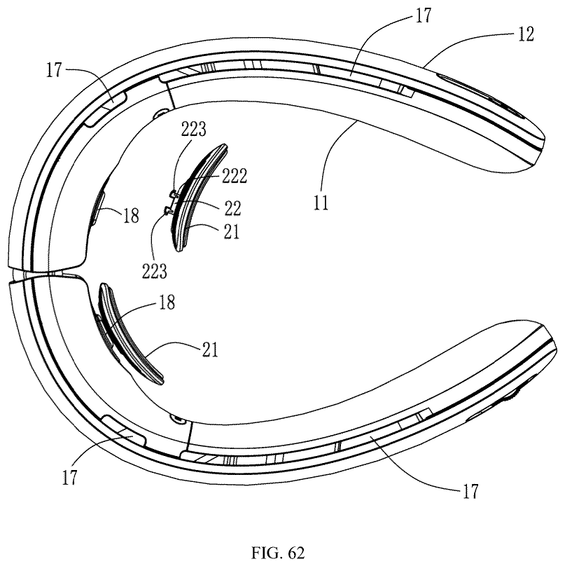

As shown in FIGS. 60 and 62, the portable fan is arranged with two support members 2 corresponding to the two clamp arms 13. When the two clamp arms 13 are pivoted, positions of the two support members 2 in contact with the user changes accordingly. However, since the cushion member 3 is arranged in the mounting cavity 181 to abut against the two support members 2, the two support members 2 can still be respectively attached well to the neck, and the portable fan can be worn comfortably.

As shown in FIGS. 59 to 61, corresponding to each fan assembly 4, each of the two clamp arms 13 defines a first air inlet 141 defined in the first side wall 11 and a second air inlet 142 defined in the second side wall 12. The receiving cavity 15 is located at two ends of the two clamp arms 13 that are connected to each other. The support member 2 is disposed at a position corresponding to the receiving cavity 15. A spacing is defined between at least a portion of the support member 2 and the first air inlet 141. Therefore, when the portable fan is in use, the support member 2 does not affect the air intaken through the first air inlet 141. Moreover, as shown in the drawings, the contact portion 21 of the support member 2 defines a through hole 211 corresponding to the first air inlet 141. In this way, the sweat, generated due to the contact portion 21 in contact with the neck, can be absorbed and evaporated in time, ensuring that the neck is dry and fresh, and a wearing experience is improved.

As shown in FIGS. 59 to 61, the second side wall 12 includes a main wall 121 and an auxiliary wall 122. The main wall 121 and the auxiliary wall 122 are arranged in a stepped manner. The second air inlet 142 is formed between the main wall 121 and the auxiliary wall 122. The second air inlet 142 is hiddenly formed between the main wall 121 and the auxiliary wall 122, and therefore, an aesthetic appearance is provided, and the hair of the user may not enter the second air inlet 142 easily, safety of the portable fan is improved.

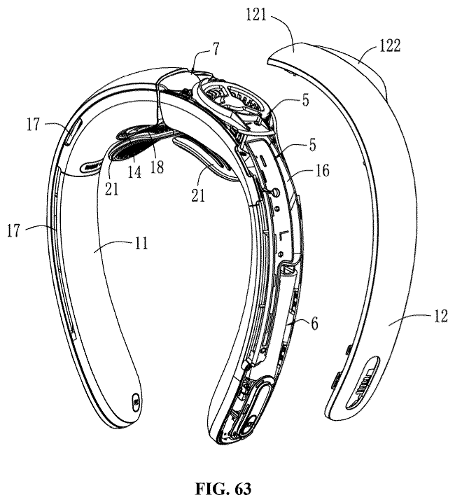

As shown in FIGS. 60 and 63, a partition assembly 5 is further arranged. The partition assembly 5 separates the receiving cavity 15 and the air duct 16, which are communicated with each other, from the other space inside the housing 1. A width of an end of the air duct 16 away from the receiving cavity 15 is less than a width of an end of the air duct 16 near the receiving cavity 15, such that a space is reserved to receive a battery 6. In the present embodiment, the battery 6 is arranged inside each of the two clamp arms 13, and two fan assemblies 3 may operate simultaneously or separately. The air outlet 17 is formed at and extends through a side of the air duct 16 and extends substantially to cover the entirety of the air duct 16. The width of the end of the air duct 16 away from the receiving cavity 15 is narrower, such that the air may be gathered easily at the narrower end, and various portions of the air outlet 17 may have an even airflow.

What is claimed is:

1. A portable fan, comprising a fan and a power supply drive assembly electrically connected to the fan; wherein the power supply drive assembly comprises a battery and a fan drive circuit electrically connected to the battery; the fan drive circuit comprises:
a master control circuit;
a three-phase drive circuit, comprising at least three signal input ends and three drive signal output ends; wherein each of the at least three signal input ends is electrically connected to the master control circuit to receive control signals; each of the three drive signal output ends is electrically connect to a respective one of three signal ends of a fan motor to respectively output the three-phase drive signal to drive the fan motor to rotate;
wherein the battery is configured to supply power to the fan drive circuit.

2. The portable fan according to claim 1, wherein the three-phase drive circuit comprises a first transistor, a second transistor, a third transistor, a seventh transistor, an eighth transistor, and a ninth transistor; a control end of the first transistor, a control end of the second transistor, a control end of the third transistor, a control end of the seventh transistor, a control end of the eighth transistor, and a control end of the ninth transistor are electrically connected to the master control circuit to receive the control signals.

3. The portable fan according to claim 2, wherein, a first conductive end of the first transistor, a first conductive end of the second transistor, and a first conductive end of the third transistor are connected to a power supply end.

4. The portable fan according to claim 3, wherein the three-phase drive circuit comprises a fourth transistor, a fifth transistor, and a sixth transistor; a control end of the fourth transistor, a control end of the fifth transistor, and a control end of the sixth transistor, are electrically connected to the master control circuit to receive the control signals.

5. The portable fan according to claim 4, wherein, a first conductive end of the fourth transistor is connected to the power supply end; a first conductive end of the fifth transistor is connected to the power supply end; a first conduction end of the sixth transistor is connected to the power supply end;
second conduction ends of the fourth transistor, the fifth transistor, and the sixth transistor are grounded.

6. The portable fan according to claim 4, wherein, a first conductive end of the seventh transistor is connected to a second conductive end of the first transistor; a second conductive end of the seventh transistor is grounded; a first conductive end of the eighth transistor is connected to a second conductive end of the second transistor; a second conductive end of the eighth transistor is grounded; a first conductive end of the ninth transistor is connected to the second conductive end of the third transistor; a second conductive end of the ninth transistor is grounded; a node between the first conductive of the seventh transistor and the second conductive of the first transistor, a node between the first conductive of the eighth transistor and the second conductive of the second transistor, and a node between the first conductive of the ninth transistor and the second conductive of the third transistor respectively serve as the three drive signal output ends.

7. The portable fan according to claim 6, wherein, the three-phase drive circuit comprises a detection circuit; the second conductive ends of the seventh transistor, the eighth transistor, and the ninth transistor are all grounded via the detection circuit; the detection circuit is electrically connected to the master control circuit; the detection circuit comprises a sense resistor and a sense capacitor; the second conductive ends of the seventh transistor, the eighth transistor, and the ninth transistor are grounded via the sense resistor and the sense capacitor sequentially; a node between the sense resistor and the sense capacitor is electrically connected to the master control circuit.

8. The portable fan according to claim 1, wherein the three-phase drive circuit comprises a filter capacitor and a sampling resistor, and one end of the sampling resistor is grounded, the sampling resistor is connected between the filter capacitor and the ground.

9. The portable fan according to claim 1, wherein the fan drive circuit further comprises an inverted-phase electric potential detection circuit, configured to detect an inverted-phase electric potential, wherein the inverted-phase electric potential detection circuit comprises three detection branches; wherein each of the three detection branches comprises a detection end and a detection output end electrically connected to the detection end; three detection ends of the three detection branches are respectively electrically connected to the three drive signal output ends; three detection output ends of the three detection branches are electrically connected to the master control circuit to respectively output a first detection signal, a second detection signal, and a third detection signal; the master control circuit is informed of a phase of the three-phase drive signal based on the first detection signal, the second detection signal, and the third detection signal to adjust the control signals.

10. The portable fan according to claim 9, wherein each of the three detection branches comprises a first resistor and a second resistor connected to the first resistor, a node between the first resistor and the second resistor is electrically connected to the master control circuit.

11. The portable fan according to claim 10, wherein each of the three detection branches further comprises a third resistor, an end of the third resistor is electrically connected to a node between the first resistor and the second resistor; and the other end of the third resistor is connected to the master control circuit.

12. The portable fan according to claim 4, wherein the at least three signal input ends are three PWM signal input ends; the control signals comprise three PWM signals configured to be input to the control end of the fourth transistor, the control end of the fifth transistor, and the control end of the sixth transistor.

13. The portable fan according to claim 1, wherein the portable fan further comprises:
a neck housing in which the fan and the power supply drive assembly are arranged; wherein the neck housing is configured to be worn around a neck of a user; and
a plurality of support members, spaced apart from each other and movably connected to the neck housing, wherein the plurality of support members are configured to be supported between the neck housing and the neck of the user.

14. The portable fan according to claim 13, wherein movement of one of the plurality of support members is independent from movement of another one of the plurality of support members.

15. The portable fan according to claim 13, wherein the neck housing has a rear center corresponding to a rear center of the neck of the user when the portable fan is worn on the neck of the user; one of the plurality of support members is disposed at a side of the rear center of the neck housing; and another one of the plurality of support members is disposed at the other side of the rear center of the neck housing; and
the one of the plurality of support members is disconnected from the another one of the plurality of support members.

16. The portable fan according to claim 13, wherein a plurality of mounting portions are arranged inside the neck housing, each of the plurality of support members is mounted on a respective one of the plurality of mounting portions.

17. The portable fan according to claim 16, wherein, a plurality of cushion members are arranged and are elastic to enable the plurality of support members to be movable; each of the plurality of cushion members is disposed between a respective one of the plurality of support members and a respective one of the mounting portions.

18. The portable fan according to claim 17, wherein each of the plurality of support members comprises a contact member and a first mating portion; the contact member has a contact surface configured to contact the neck of the user; an end of the first mating portion is mated with the respect mounting portion; the other end of the first mating portion is protruding out of the respective mounting portion and is mated with another surface of the contact member away from the contact surface; the cushion member is disposed between the end of the first mating portion and the mounting portion.

19. The portable fan according to claim 18, wherein each of the plurality of support members further comprises two second mating portions;
when the two second mating portions are pressed, the two second mating portions are moved close to each other to extend into or move out of the respective mounting portion; and
when pressing on the two second mating portions is released, the two second mating portions are secured to the respective mounting portion or moved out of the respective mounting portion.

20. The portable fan according to claim 17, wherein, each of the plurality of cushion members is made of silicone, and 15% to 25% of an original size of each of the plurality of cushion members is capable of being compressed.

21. The portable fan according to claim 13, wherein, an inner side of the neck housing facing the plurality of support members defines a plurality of air inlets through which air is capable of entering the neck housing.

22. The portable fan according to claim 21, wherein an orthographic projection of each of the plurality of support members onto the neck housing covers the plurality of air inlets.
